(19) United States
(12) Patent Application Publication
(10) Pub. No.: US 2014/0061534 A1
(43) Pub. Date: Mar. 6, 2014

(54) LIQUID-CRYSTALLINE MEDIUM

(71) Applicant: Merck Patent GmbH, Darmstadt (DE)

(72) Inventors: Mark GOEBEL, Darmstadt (DE); Harald HIRSCHMANN, Darmstadt (DE); Lars LIETZAU, Darmstadt (DE); Volker REIFFENRATH, Rossdorf (DE); Sabine SCHOEN, Herten (DE); Brigitte SCHULER, Grossostheim (DE)

(21) Appl. No.: 14/014,721

(22) Filed: Aug. 30, 2013

Related U.S. Application Data
(60) Provisional application No. 61/714,900, filed on Oct. 17, 2012.

(30) Foreign Application Priority Data
Aug. 31, 2012 (EP) 12006203.9

(51) Int. Cl. C09K 19/34; C09K 19/30

(52) U.S. Cl. CPC C09K 19/3402; C09K 19/3066
USPC 252/299.61; 252/299.63; 585/20

(57) ABSTRACT

The invention relates to a liquid-crystalline medium comprising at least one compound of the formula I,

in which
R¹ has the meanings indicated in claim 1,
and to the use thereof in liquid-crystalline media and in electro-optical liquid-crystal displays.

### SUMMARY OF INVENTION

The present invention relates to a liquid-crystalline medium (LC medium), to the use thereof for electro-optical purposes, and to LC displays containing this medium.

Liquid crystals are used principally as dielectrics in display devices, since the optical properties of such substances can be modified by an applied voltage. Electro-optical devices based on liquid crystals are extremely well known to the person skilled in the art and can be based on various effects. Examples of such devices are cells having dynamic scattering, DAP (deformation of aligned phases) cells, guest/host cells, TN cells having a “twisted nematic” structure, STN (“super-twisted nematic”) cells, SBE (“superbirefringence effect”) cells and OMI (“optical mode interference”) cells. The commonest display devices are based on the Schadt-Helfrich effect and have a twisted nematic structure. In addition, there are also cells which work with an electric field parallel to the substrate and liquid-crystal plane, such as, for example, IPS (“in-plane switching”) cells. TN, STN, FFS (fringe field switching) and IPS cells, in particular, are currently commercially interesting areas of application for the media according to the invention.

The liquid-crystal materials must have good chemical and thermal stability and good stability to electric fields and electromagnetic radiation. Furthermore, the liquid-crystal materials should have low viscosity and produce short addressing times, low threshold voltages and high contrast in the cells.

They should furthermore have a suitable mesophase, for example a nematic or cholesteric mesophase for the above-mentioned cells, at the usual operating temperatures, i.e. in the broadest possible range above and below room temperature. Since liquid crystals are generally used as mixtures of a plurality of components, it is important that the components are readily miscible with one another. Further properties, such as the electrical conductivity, the dielectric anisotropy and the optical anisotropy, have to satisfy various requirements depending on the cell type and area of application. For example, materials for cells having a twisted nematic structure should have positive dielectric anisotropy and low electrical conductivity.

For example, for matrix liquid-crystal displays with integrated non-linear elements for switching individual pixels (MLC displays), media having large positive dielectric anisotropy, broad nematic phases, relatively low birefringence, very high specific resistance, good UV and temperature stability and low vapour pressure are desired.

Matrix liquid-crystal displays of this type are known. Examples of non-linear elements which can be used to individually switch the individual pixels are active elements (i.e. transistors). The term “active matrix” is then used, where a distinction can be made between two types:
1. MOS (metal oxide semiconductor) or other diodes on silicon wafers as substrate.
2. Thin-film transistors (TFTs) on a glass plate as substrate.

The use of single-crystal silicon as substrate material restricts the display size, since even modular assembly of various part-displays results in problems at the joints.

In the case of the more promising type 2, which is preferred, the electro-optical effect used is usually the TN effect. A distinction is made between two technologies: TFTs comprising compound semiconductors, such as, for example, CdSe, or TFTs based on polycrystalline or amorphous silicon. Intensive work is being carried out worldwide on the latter technology.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is opposite each switchable pixel.

The TFT displays usually operate as TN cells with crossed polarisers in transmission and are backlit.

The term MLC displays here encompasses any matrix display with integrated non-linear elements, i.e., besides the active matrix, also displays with passive elements, such as varistors or diodes (MIM=metal-insulator-metal).

MLC displays of this type are particularly suitable for TV applications (for example pocket televisions) or for high-information displays for computer applications (laptops) and in automobile or aircraft construction. Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff., Paris; STROMER, M., Proc. Eurodisplay 84, September 1984: Design of Thin Film Transistors for Matrix Addressing of Television Liquid Crystal Displays, pp. 145 ff., Paris]. With decreasing resistance, the contrast of an MLC display deteriorates, and the problem of after-image elimination may occur. Since the specific resistance of the liquid-crystal mixture generally drops over the life of an MLC display owing to interaction with the interior surfaces of the display, a high (initial) resistance is very important in order to obtain acceptable lifetimes. In particular in the case of low-volt mixtures, it was hitherto impossible to achieve very high specific resistance values. It is furthermore important that the specific resistance exhibits the smallest possible increase with increasing temperature and after heating and/or UV exposure. The low-temperature properties of the mixtures from the prior art are also particularly disadvantageous. It is demanded that no crystallisation and/or smectic phases occur, even at low temperatures, and the temperature dependence of the viscosity is as low as possible. The MLC displays from the prior art thus do not satisfy today's requirements.

Besides liquid-crystal displays which use backlighting, i.e. are operated transmissively and if desired transflectively, reflective liquid-crystal displays are also particularly interesting. These reflective liquid-crystal displays use the ambient light for information display. They thus consume significantly less energy than backlit liquid-crystal displays having a corresponding size and resolution. Since the TN effect is characterised by very good contrast, reflective displays of this type can even be read well in bright ambient conditions. This is already known of simple reflective TN displays, as used, for example, in watches and pocket calculators. However, the principle can also be applied to high-quality, higher-resolution active matrix-addressed displays, such as, for example, TFT displays. Here, as already in the transmissive TFT-TN displays which are generally conventional, the use of liquid crystals of low birefringence (Δn) is necessary in order to achieve low optical retardation (d·Δn). This low optical retardation results in usually acceptably low viewing-angle dependence of the contrast (cf. DE 30 22 818). In reflective displays, the use of liquid crystals of low birefringence is even more important than in transmissive displays since the effective layer thickness through which the light passes is approximately twice as large in reflective displays as in transmissive displays having the same layer thickness.

For TV and video applications, displays having fast response times are required in order to be able to reproduce multimedia content, such as, for example, films and video games, in near-realistic quality. Such short response times can be achieved, in particular, if liquid-crystal media having low values for the viscosity, in particular the rotational viscosity γ₁, and having high optical anisotropy (Δn) are used.

In order to achieve 3D effects by means of shutter spectacles, use is made of, in particular, fast-switching mixtures having low rotational viscosities and correspondingly high optical anisotropy (Δn). Electro-optical lens systems by means of which a 2-dimensional representation of a display can be converted into a 3-dimensional autostereoscopic representation can be achieved using mixtures having high optical anisotropy (Δn).

Thus, there continues to be a great demand for MLC displays having very high specific resistance at the same time as a large working-temperature range, short response times, even at low temperatures, and a low threshold voltage which do not exhibit these disadvantages or only do so to a reduced extent.

In the case of TN (Schadt-Helfrich) cells, media are desired which facilitate the following advantages in the cells:
extended nematic phase range (in particular down to low temperatures)
the ability to switch at extremely low temperatures (outdoor use, automobiles, avionics)
increased resistance to UV radiation (longer lifetime)
low threshold voltage.

The media available from the prior art do not enable these advantages to be achieved while simultaneously retaining the other parameters.

In the case of supertwisted (STN) cells, media are desired which facilitate greater multiplexability and/or lower threshold voltages and/or broader nematic phase ranges (in particular at low temperatures). To this end, a further widening of the available parameter latitude (clearing point, smectic-nematic transition or melting point, viscosity, dielectric parameters, elastic parameters) is urgently desired.

One of the most important properties of modern LCDs is correct reproduction of moving images. If the response speed of the liquid-crystalline medium used is too slow, this causes undesired artefacts in the display of such content. The physical parameters which essentially determine the response time of a liquid-crystal mixture are the rotational viscosity γ₁ and the elastic constants. The latter are also particularly important for ensuring a good black state of the LCD. In general, however, it is observed that the clearing point of the mixture and thus the rotational viscosity of the mixture is also increased with an increase in the elastic constants, meaning that an improvement in the response time is not possible. In particular in the case of LC displays for TV and video applications (for example LCD TVs, monitors, PDAs, notebooks, games consoles), a significant reduction in the response times is desired. A reduction in the layer thickness d (“cell gap”) of the LC medium in the LC cell theoretically results in faster response times, but requires LC media having higher birefringence Δn in order to ensure an adequate optical retardation (d·Δn). However, the LC materials of high birefringence known from the prior art generally also have high rotational viscosity at the same time, which in turn has an adverse effect on the response times.

There is therefore a demand for LC media which simultaneously have fast response times, low rotational viscosities and relatively high birefringence.

The invention provides media, in particular for MLC, TN, STN, OCB, positive VA, FFS, PS (=polymer stabilised)-FFS, IPS, PS-IPS displays of this type, which have the desired properties indicated above and do not exhibit the disadvantages indicated above or only do so to a reduced extent. In particular, the LC media should have fast response times and low rotational viscosities at the same time as relatively high birefringence. In addition, the LC media should have a high clearing point, high dielectric anisotropy, a low threshold voltage and very good low-temperature stability (LTS).

It has now been found that such media can be produced if LC media comprising one or more compounds of the formula I are used.

The invention relates to a liquid-crystalline medium, characterised in that it comprises one or more compounds of the formula I,

in which
R¹ denotes an alkyl or alkoxy radical having 1 to 15 C atoms, where, in addition, one or more CH₂ groups in these radicals may each be replaced, independently of one another, by —C≡C—, —CF₂O—, —CH═CH—,

—O—, —CO—O—, —O—CO— in such a way that O atoms are not linked directly to one another, and in which, in addition, one or more H atoms may be replaced by halogen.

The compounds of the formula I result in LC mixtures having the desired properties indicated above, in particular in LC mixtures having very low rotational viscosity. The mixtures according to the invention have very large elastic constants and thus facilitate very good response times. Furthermore, the mixtures according to the invention are stable at at least −20° C. and exhibit no tendency towards crystallisation. The rotational viscosities γ₁ are generally <120 mPa·s. Furthermore, the mixtures according to the invention are distinguished by a very good ratio of rotational viscosity γ₁ and clearing point, a high value for the optical anisotropy and high birefringence Δn, as well as fast response times, a low threshold voltage, a high clearing point, a high positive dielectric anisotropy and a broad nematic phase range. Furthermore, the compounds of the formula I are very readily soluble in liquid-crystalline media.

The compounds of the formula I have a broad range of applications and are distinguished, in particular, by their very large elastic constants. Depending on the choice of substituents, they can serve as base materials of which liquid-crystalline media are predominantly composed; however, liquid-crystalline base materials from other classes of compound can also be added to the compounds of the formula I in order, for example, to influence the dielectric and/or optical anisotropy of a dielectric of this type and/or to optimise its threshold voltage and/or its rotational viscosity. The result are LC mixtures according to the invention which support a good black state of the display, which is crucial for the contrast of the display, owing to high elastic constants and at the same time facilitate very good response times.

R¹ in the compounds of the formula I and the sub-formulae preferably denotes a straight-chain alkyl radical, in particular having 3-5 C atoms. In a further preferred embodiment, one or more CH₂ groups in the alkyl radical may also be replaced by —CH═CH—.

Particularly preferred compounds of the formula I are shown below:

Very particular preference is given to the compound of the formula I-2.

In the pure state, the compounds of the formula I are colourless and form liquid-crystalline mesophases in a temperature range which is favourably located for electro-optical use. They are stable chemically, thermally and to light.

The compounds of the formula I are prepared by methods known per se, as described in the literature (for example in the standard works, such as HoubenWeyl, Methoden der organischen Chemie [Methods of Organic Chemistry], Georg-Thieme-Verlag, Stuttgart), to be precise under reaction conditions which are known and suitable for the said reactions. Use can also be made here of variants known per se which are not mentioned here in greater detail. The compounds of the formula I are preferably prepared from the following starting materials:

If R¹ in the formulae above and below denotes an alkyl radical and/or an alkoxy radical, this may be straight-chain or branched. It is preferably straight-chain, has 2, 3, 4, 5, 6, or 7 C atoms and accordingly preferably denotes ethyl, propyl, butyl, pentyl, hexyl, heptyl, ethoxy, propoxy, butoxy, pentoxy, hexoxy or heptoxy, furthermore, nonyl, decyl, undecyl, dodecyl, tridecyl, tetradecyl, pentadecyl, methoxy, octoxy, nonoxy, decoxy, undecoxy, dodecoxy, tridecoxy or tetradedoxy.

Oxaalkyl preferably denotes straight-chain 2-oxapropyl (=methoxy-methyl), 2-(=ethoxymethyl) or 3-oxabutyl (=2-methoxyethyl), 2-, 3- or 4-oxaheptyl, 2-, 3-, 4- or 5-oxahexyl, 2-, 3-, 4-, 5- or 6-oxaheptyl, 2-, 3-, 4-, 5-, 6-, or 7-oxaoctyl, 2-, 3-, 4-, 5-, 6-, 7- or 8-oxanonyl, 2-, 3-, 4-, 5-, 6-, 7-, 8- or 9-oxadexyl.

If R¹ denotes an alkyl radical in which one CH₂ group has been replaced by —CH═CH—, this may be straight-chain or branched. It is preferably straight-chain and has 2 to 10 C atoms. Accordingly, it denotes, in particular, vinyl, prop-1-, or prop-2-enyl, but-1-, 2- or but-3-enyl, pent-1-, 2-, 3- or pent-4-enyl, hex-1-, 2-, 3-, 4- or hex-5-enyl, hept-1-, 2-, 3-, 4-, 5- or hept-6-enyl, oct-1-, 2-, 3-, 4-, 5-, 6- or oct-7-enyl, non-1-, 2-, 3-, 4-, 5-, 6-, 7- or non-8-enyl, dec-1-, 2-, 3-, 4-, 5-, 6-, 7-, 8- or dec-9-enyl. These radicals may also be mono- or polyhalogenated. Preferred fluorinated radicals are CH═CF₂, CF═CF₂, CF═CHF, CH═CHF.

If R¹ denotes an alkyl or alkenyl radical which is at least monosubstituted by halogen, this radical is preferably straight-chain and halogen is preferably F or Cl. In the case of polysubstitution, halogen is preferably F. The resultant radicals also include perfluorinated radicals. In the case of monosubstitution, the fluorine or chlorine substituent can be in any desired position, but is preferably in the ω position.

Further preferred embodiments are indicated below:
The medium additionally comprises one or more neutral compounds of the formulae II and/or III,

in which
A denotes 1,4-phenylene or trans-1,4-cyclohexylene,
a is 0 or 1,
R³ denotes alkenyl having 2 to 9 C atoms,
and R⁴ has the meaning indicated for R¹ in formula I and preferably denotes alkyl having 1 to 12 C atoms or alkenyl having 2 to 9 C atoms.
The compounds of the formula II are preferably selected from the following formulae,

in which R^{3a} and R^{4a} each, independently of one another, denote H, CH₃, C₂H₅ or C₃H₇, and “alkyl” denotes a straight-chain alkyl group having 1 to 8 C atoms. Particular preference is given to compounds of the formulae IIa and IIf, in particular in which R^{3a} denotes H or CH₃, and compounds of the formula IIc, in particular in which R^{3a} and R^{4a} denote H, CH₃ or C₂H₅.
Preference is furthermore given to compounds of the formula II which have a non-terminal double bond in the alkenyl side chain:

Very particularly preferred compounds of the formula II are the compounds of the formulae

Of the compounds of the formulae IIa-1 to IIa-19, particular preference is given, in particular, to the compounds of the formulae IIa-1, IIa-2, IIa-3 and IIa-5.
Besides one or more compounds of the formula I, the liquid-crystalline media according to the invention particularly preferably comprise 5-70% by weight, in particular 10-50% by weight and very particularly preferably 20-45% by weight, of compounds of the formula

The compounds of the formula III are preferably selected from the following formulae,

in which “alkyl” and R^{3a} have the meanings indicated above, and R^{3a} preferably denotes H or CH₃. Particular preference is given to compounds of the formula IIIb;
Very particular preference is given to the compound of the formula IIIb-1,

in which “alkyl” has the meaning indicated above and preferably denotes CH₃, furthermore C₂H₅ or n-C₃H₇.
The medium preferably additionally comprises one or more compounds selected from the following formulae IV to VIII,

in which
R⁰ has the meanings indicated in claim 6,
X⁰ denotes F, Cl, a mono- or polyfluorinated alkyl or alkoxy radical, in each case having 1 to 6 C atoms, a mono- or polyfluorinated alkenyl or alkenyloxy radical, in each case having 2 to 6 C atoms.
Y¹⁻⁶ each, independently of one another, denote H or F,
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO—, —CF₂O— or —OCF₂—, in the formulae V and VI also a single bond, and
r denotes 0 or 1.
In the above formulae, X⁰ is preferably F, Cl or a mono- or polyfluorinated alkyl or alkoxy radical having 1, 2 or 3 C atoms or a mono- or polyfluorinated alkenyl radical or alkenyloxy radical having 2 or 3 C atoms. X⁰ is particularly preferably F, Cl, CF₃, CHF₂, OCF₃, OCHF₂, OCHFCF₃, OCHFCHF₂, OCHFCH₂F, OCF₂CH₃, OCF₂CHF₂, OCF₂CH₂F, OCF₂CF₂CHF₂, OCF₂CF₂CH₂F, OCFHCF₂CF₃, OCFHCF₂CHF₂, OCH═CF₂, OCF═CF₂, OCF₂CHFCF₃, OCF₂CF₂CF₃, OCF₂CF₂CClF₂, OCClFCF₂CF₃, CF═CF₂, CF═CHF, OCH═CF₂, OCF═CF₂, or CH═CF₂.
In the compounds of the formulae IV to VIII, X⁰ preferably denotes F or OCF₃, furthermore OCHF₂, CF₃, CF₂H, Cl, OCH═CF₂. R⁰ is preferably straight-chain alkyl or alkenyl having up to 6 C atoms.
The compounds of the formula IV are preferably selected from the following formulae,

in which R⁰ and X⁰ have the meanings indicated in claim 6.
Preferably, R⁰ in formula IV denotes alkyl having 1 to 8 C atoms and X⁰ denotes F, Cl, OCHF₂ or OCF₃, furthermore OCH═CF₂. In the compound of the formula IVb, R⁰ preferably denotes alkyl or alkenyl. In the compound of the formula IVd, X⁰ preferably denotes Cl, furthermore F.
The compounds of the formula V are preferably selected from the formulae Va to Vj,

in which R⁰ and X⁰ have the meanings indicated in claim 6. Preferably, R⁰ in formula V denotes alkyl having 1 to 8 C atoms and X⁰ denotes F, OCF₃ or OCH═CF₂.
The medium comprises one or more compounds of the formula VI-1,

particularly preferably those selected from the following formulae:

in which R⁰ and X⁰ have the meanings indicated in claim 6. Preferably, R⁰ in formula VI denotes alkyl having 1 to 8 C atoms and X⁰ denotes F, furthermore CF₃ and OCF₃.
The medium comprises one or more compounds of the formula VI-2,

particularly preferably those selected from the following formulae,

in which R⁰ and X⁰ have the meanings indicated in claim 6. Preferably, R⁰ in formula VI denotes alkyl having 1 to 8 C atoms and X⁰ denotes F;
The medium preferably comprises one or more compounds of the formula VII in which Z⁰ denotes —CF₂O—, —CH₂CH₂— or —COO—, particularly preferably those selected from the following formulae,

in which R⁰ and X⁰ have the meanings indicated in claim 6. Preferably, R⁰ in formula VII denotes alkyl having 1 to 8 C atoms and X⁰ denotes F, furthermore OCF₃ and CF₃.
The compounds of the formula VIII are preferably selected from the following formulae,

in which R⁰ and X⁰ have the meanings indicated above. R⁰ in formula VIII preferably denotes a straight-chain alkyl radical having 1 to 8 C atoms. X⁰ preferably denotes F.
The medium additionally comprises one or more compounds of the following formula,

in which R⁰, X⁰, Y¹ and Y² have the meaning indicated above, and

each, independently of one another, denote

where the rings A and B do not both simultaneously denote 1,4-cyclohexylene;
The compounds of the formula IX are preferably selected from the following formulae,

in which R⁰ and X⁰ have the meanings indicated in claim 6. Preferably, R⁰ in formula IX denotes alkyl having 1 to 8 C atoms and X⁰ denotes F. Particular preference is given to compounds of the formula IXa;
The medium additionally comprises one or more compounds selected from the following formulae,

in which R⁰, X⁰ and Y¹⁻⁴ have the meanings indicated in claim 6, and

each, independently of one another, denote

The compounds of the formulae X and XI are preferably selected from the following formulae,

in which R⁰ and X⁰ have the meanings indicated in claim 6. Preferably, R⁰ denotes alkyl having 1 to 8 C atoms and X⁰ denotes F. Particularly preferred compounds are those in which Y¹ denotes F and Y² denotes H or F, preferably F.
The medium additionally comprises one or more compounds of the following formula XII,

in which R¹ and R² each, independently of one another, denote alkyl, alkenyl, alkoxy, oxaalkyl, fluoroalkyl or alkenyloxy, each having up to 9 C atoms, and preferably each, independently of one another, denote alkyl or alkenyl having 1 to 8 C atoms or 2 to 8 C atoms respectively.
Preferred compounds of the formula XII are the compounds of the formulae

in which
alkyl and alkyl* each, independently of one another, denote a straight-chain alkyl radical having 1 to 8 C atoms, and
alkenyl and
alkenyl* each, independently of one another, denote a straight-chain alkenyl radical having 2 to 8 C atoms.
Particular preference is given to the compounds of the formulae XII-2 and XII-4.
Particularly preferred compounds of the formula XII-2 are the compounds of the formulae XII-2a, XII-2b and XII-2c:

Particularly preferred compounds of the formula XII-4 are the compounds of the formulae XII-4a, XII-4b and XII-4c:

The compound(s) of the formula XII are preferably employed in amounts of 3-40% by weight.
The medium additionally comprises one or more compounds selected from the following formulae,

in which R⁰, X⁰, Y¹ and Y² have the meanings indicated in claim 6. Preferably, R⁰ denotes alkyl having 1 to 8 C atoms and X⁰ denotes F or Cl;
The compounds of the formulae XIII and XIV are preferably selected from the compounds of the formulae

in which R⁰ and X⁰ have the meanings indicated in claim 6. R⁰ preferably denotes alkyl having 1 to 8 C atoms. In the compounds of the formula XIII, X⁰ preferably denotes F or Cl.
The medium additionally comprises one or more compounds of the formulae D1, D2, D3, D4 and/or D5,

in which Y¹, Y², R⁰ and X⁰ have the meanings indicated in claim 6. Preferably, R⁰ denotes alkyl having 1 to 8 C atoms and X⁰ denotes F.
Particular preference is given to compounds of the formulae

in which R⁰ has the meanings indicated above and preferably denotes straight-chain alkyl having 1 to 6 C atoms, in particular C₂H₅, n-C₃H₇ or n-C₅H₁₁.
The medium additionally comprises one or more compounds of the following formula XVII,

in which Y¹, R¹ and R² have the meanings indicated above. R¹ and R² preferably each, independently of one another, denote alkyl or alkenyl having 1 or 2 to 8 C atoms; Y¹ and Y² preferably both denote F. The compound(s) of the formula XVII are preferably employed in amounts of 3-30% by weight, based on the medium.
The medium additionally comprises one or more compounds of the following formula:

in which X⁰, Y¹ and Y² have the meanings indicated in claim 6, and “alkenyl” denotes C₂₋₇-alkenyl. Particular preference is given to compounds of the following formula:

in which R^{3a} has the meaning indicated above and preferably denotes H;
The medium additionally comprises one or more tetracyclic compounds selected from the formulae XIX to XXVIII,

in which Y¹⁻⁴, R⁰ and X⁰ each, independently of one another, have one of the meanings indicated above. X⁰ is preferably F, Cl, CF₃, OCF₃ or OCHF₂. R⁰ preferably denotes alkyl, alkoxy, oxaalkyl, fluoroalkyl or alkenyl, each having up to 8 C atoms.
In the compounds of the formulae XIX to XXVIII, R⁰ preferably denotes straight-chain alkyl. X⁰ is preferably F or OCF₃, furthermore CF₃. Y¹ and Y² preferably denote Y¹═F and Y²═H or Y¹═Y²═F.
Particularly preferred compounds of the formula XIX to XXVIII are the compounds of the formula XXV in which X⁰ preferably denotes F, furthermore OCF₃.
Preferred mixtures comprise at least one compound from the group S-1, S-2, S-3 and S-4,

since these compounds help, inter alia, to suppress the smectic phases of the mixtures.
The medium preferably comprises one or more neutral compounds of the general formula N,

in which
R^{N1} and R^{N2} each, independently of one another, denote an alkyl or alkoxy radical having 1 to 15 C atoms, where, in addition, one or more CH₂ groups in these radicals may each be replaced, independently of one another, by —C≡C—, —CF₂O—,

—O—, —CO—O—, —O—CO— in such a way that O atoms are not linked directly to one another, and in which, in addition, one or more H atoms may be replaced by halogen,
rings A^{N1}, A^{N2} and A^{N3} each, independently of one another, denote 1,4-phenylene, 2-fluoro-1,4-phenylene, 3-fluoro-1,4-phenylene, trans-1,4-cyclohexylene, in which, in addition, one or two CH₂ groups may be replaced by —O—, or 1,4-cyclohexenylene,
Z^{N1} and Z^{N2} each, independently of one another, denote a single bond, —CH₂CH₂—, —COO—, —OCO—, —C≡C—, —CH₂O—, —OCH₂—, —CF₂O—, —OCF₂—, or —CH═CH—,
n denotes 0, 1 or 2.
Preferred compounds of the formula N are shown below:

in which
alkyl and alkyl* each, independently of one another, denote a straight-chain alkyl radical having 1 to 9 C atoms, preferably 2 to 6 C atoms, and alkenyl and alkenyl* each, independently of one another, denote a straight-chain alkenyl radical having 2-6 C atoms
Of the compounds of the formula N, particular preference is given to the compounds of the formulae N-1, N2, N-3, N-4, N-8, N-9, N-14, N-15, N-17, N-18, N-19, N-20, N-21, N-22, N-23, N-24, N-25, N-31, N-33 and N-36.
The medium additionally comprises one or more compounds of the formulae St-1 to St-3,

in which R⁰, Y¹, Y² and X⁰ have the meanings indicated in claim 6. R⁰ preferably denotes straight-chain alkyl, preferably having 1-6 C atoms. X⁰ is preferably F, CF₃ or OCF₃. Y¹ preferably denotes F. Y² preferably denotes F. Furthermore, preference is given to compounds in which Y¹═F and Y²═H. The compounds of the formulae St-1 to St-3 are preferably employed in the mixtures according to the invention in a concentration of 3-30% by weight, in particular 5-25% by weight.
The medium additionally comprises one or more pyrimidine or pyridine compounds of the formulae Py-1 to Py-5,

in which R⁰ is preferably straight-chain alkyl having 2-5 C atoms. x denotes 0 or 1, preferably x=1. Preferred mixtures comprise 3-30% by weight, in particular 5-20% by weight, of this (these) pyri(mi)dine compound(s).
The medium additionally comprises one or more compounds selected from the group of the compounds of the formulae Y-1, Y-2, Y-3 and Y-4,

in which
R^{2A} denotes H, an alkyl or alkoxy radical having 1 to 15 C atoms, where, in addition, one or more CH₂ groups in these radicals may each be replaced, independently of one another, by —C≡C—, —CF₂O—, —CH═CH—,

—O—, —CO—O—, —O—CO— in such a way that O atoms are not linked directly to one another, and in which, in addition, one or more H atoms may be replaced by halogen,
L¹⁻⁴ and L² each, independently of one another, denote F, Cl, CF₃ or CHF₂, preferably each denote F,
Z² and Z^{2′} each, independently of one another, denote a single bond, —CH₂CH₂—, —CH═CH—, —CF₂O—, —OCF₂—, —CH₂O—, —OCH₂—, —COO—, —OCO—, —C₂F₄—, —CF═CF—, —CH═CHCH₂O—,
p denotes 0, 1 or 2,
q denotes 0 or 1,
(O)CᵥH₂ᵥ₊₁ denotes OCᵥH₂ᵥ₊₁ oder CᵥH₂ᵥ₊₁, and
v denotes 1 to 6.
Particularly preferred compounds of the formulae Y-1 to Y-4 are shown below:

Of the compounds shown, particular preference is given to the compounds of the formulae Y-1a, Y-1c, Y-1e, Y-1g, Y-1j, Y-1r, Y-1t, Y-2b, Y-2h, Y-2j and Y-3a.
The proportion of the compounds of the formulae Y-1 to Y-3 in the mixtures according to the invention is preferably 0-30% by weight.
In the formulae given above and below,

preferably denotes

R⁰ is preferably straight-chain alkyl or alkenyl having 2 to 7 C atoms;
X⁰ is preferably F, furthermore OCF₃, OCH═CF₂, C₁ or CF₃;
The medium preferably comprises one, two or three compounds of the formula I;
The medium preferably comprises one or more compounds selected from the group of the compounds of the formulae I, II, III, V, VI-1, VI-2, XII, XIII, XIV, XVII, XXIII, XXV;
The medium preferably comprises one or more compounds of the formula VI-1;
The medium preferably comprises one or more compounds of the formula VI-2;
The medium preferably comprises 1-30% by weight, preferably 2-20% by weight, particularly preferably 2-15% by weight, of compounds of the formula I;
The proportion of compounds of the formulae II-XXVII in the mixture as a whole is preferably 20 to 99% by weight;
The medium preferably comprises 25-80% by weight, particularly preferably 30-70% by weight, of compounds of the formulae II and/or III;
The medium preferably comprises 0-70% by weight, particularly preferably 20-60% by weight, of compounds of the formula IIa-1;
The medium preferably comprises 0-25% by weight, particularly preferably 5-25% by weight, of compounds of the formula IIa-2;
The medium preferably comprises 0-30% by weight, particularly preferably 5-25% by weight, of compounds of the formula IIa-3;
The medium preferably comprises 0-25% by weight, particularly preferably 5-25% by weight, of compounds of the formula IIa-5;
The medium preferably comprises 5-40% by weight, particularly preferably 10-30% by weight, of compounds of the formula V;
The medium preferably comprises 3-30% by weight, particularly preferably 6-25% by weight, of compounds of the formula VI-1;
The medium preferably comprises 2-30% by weight, particularly preferably 4-25% by weight, of compounds of the formula VI-2;
The medium preferably comprises 5-40% by weight, particularly preferably 10-30% by weight, of compounds of the formula XII;
The medium preferably comprises 1-25% by weight, particularly preferably 2-15% by weight, of compounds of the formula XIII;
The medium preferably comprises 5-45% by weight, particularly preferably 10-35% by weight, of compounds of the formula XIV;
The medium preferably comprises 1-20% by weight, particularly preferably 2-15% by weight, of compounds of the formula XVI;
The medium preferably comprises 5-30% by weight, particularly preferably 8-22% by weight, of compounds of the formula Va in which X⁰═OCH═CF₂;

It has been found that even a relatively small proportion of compounds of the formula I mixed with conventional liquid-crystal materials, but in particular with one or more compounds of the formulae II to XXVIII, results in a significant increase in the low-temperature stability without the rotational viscosity γ₁ being influenced or only being influenced slightly. The liquid-crystalline medium according to the invention is furthermore distinguished by its relatively high values for the birefringence and by its light stability, with broad nematic phases having low smectic-nematic transition temperatures being observed at the same time, improving the shelf life. At the same time, the mixtures exhibit very low threshold voltages and very good values for the VHR on exposure to UV.

The expression “alkyl” or “alkyl*” in this application encompasses straight-chain and branched alkyl groups having 1-7 carbon atoms, in particular the straight-chain groups methyl, ethyl, propyl, butyl, pentyl, hexyl and heptyl. Groups having 1-6 carbon atoms are generally preferred.

The expression “O-alkyl” in this application encompasses straight-chain and branched alkoxy groups.

The expression “alkenyl” or “alkenyl*” in this application encompasses straight-chain and branched alkenyl groups having 2-7 carbon atoms, in particular the straight-chain groups. Preferred alkenyl groups are C₂-C₇-1E-alkenyl, C₄-C₇-3E-alkenyl, C₅-C₇-4-alkenyl, C₆-C₇-5-alkenyl and C₇-6-alkenyl, in particular C₂-C₇-1E-alkenyl, C₄-C₇-3E-alkenyl and C₅-C₇-4-alkenyl. Examples of particularly preferred alkenyl groups are vinyl, 1E-propenyl, 1E-butenyl, 1E-pentenyl, 1E-hexenyl, 1E-heptenyl, 3-butenyl, 3E-pentenyl, 3E-hexenyl, 3E-heptenyl, 4-pentenyl, 4Z-hexenyl, 4E-hexenyl, 4Z-heptenyl, 5-hexenyl, 6-heptenyl and the like. Groups having up to 5 carbon atoms are generally preferred.

The expression “fluoroalkyl” in this application encompasses straight-chain groups having at least one fluorine atom, preferably a terminal fluorine, i.e. fluoromethyl, 2-fluoroethyl, 3-fluoropropyl, 4-fluorobutyl, 5-fluoropentyl, 6-fluorohexyl and 7-fluoroheptyl. However, other positions of the fluorine are not excluded.

The expression “oxaalkyl” or “alkoxy” in this application encompasses straight-chain radicals of the formula C₁H₂ₙ₊₁—O—(CH₂)ₘ, in which n and m each, independently of one another, denote 1 to 6. m may also denote 0. Preferably, n=1 and m=1-6 or m=0 and n=1-3.

Through a suitable choice of the meanings of R¹ and R² in formula I, the addressing times, the threshold voltage, the steepness of the transmission characteristic lines, etc., can be modified in the desired manner. For example, 1E-alkenyl radicals, 3E-alkenyl radicals, 2E-alkenyloxy radicals and the like generally result in shorter addressing times, improved nematic tendencies and a higher ratio between the elastic constants k₃₃ (bend) and k₁₁ (splay) compared with alkyl and alkoxy radicals. 4-Alkenyl radicals, 3-alkenyl radicals and the like generally give lower threshold voltages and lower values of k₃₃/k₁₁ compared with alkyl and alkoxy radicals. The mixtures according to the invention are distinguished, in particular, by high K₁ values and thus have significantly faster response times than the mixtures from the prior art.

The optimum mixing ratio of the compounds of the above-mentioned formulae depends substantially on the desired properties, on the choice of the components of the above-mentioned formulae and on the choice of any further components that may be present.

Suitable mixing ratios within the range indicated above can easily be determined from case to case.

The total amount of compounds of the above-mentioned formulae in the mixtures according to the invention is not crucial. The mixtures can therefore comprise one or more further components for the purposes of optimisation of various properties. However, the observed effect on the desired improvement in the properties of the mixture is generally greater, the higher the total concentration of compounds of the above-mentioned formulae.

In a particularly preferred embodiment, the media according to the invention comprise compounds of the formulae IV to VIII in which X⁰ denotes F, OCF₃, OCHF₂, OCH═CF₂, OCF═CF₂ or OCF₂—CF₂H. A favourable synergistic action with the compounds of the formula I results in particularly advantageous properties. In particular, mixtures comprising compounds of the formulae I and VI, or I and XI, or I and VI and XI are distinguished by their low threshold voltages.

The individual compounds of the above-mentioned formulae and the sub-formulae thereof which can be used in the media according to the invention are either known or can be prepared analogously to the known compounds.

The invention also relates to electro-optical displays, such as, for example, TN, STN, TFT, OCB, IPS, PS-IPS, FFS, PS-FFS, positive VA or MLC displays, having two plane-parallel outer plates, which, together with a frame, form a cell, integrated non-linear elements for switching individual pixels on the outer plates, and a nematic liquid-crystal mixture having positive dielectric anisotropy and high specific resistance located in the cell, which contain media of this type, and to the use of these media for electro-optical purposes.

Furthermore, the mixtures according to the invention are also suitable for positive VA applications, also referred to as HT-VA applications. These are taken to mean electro-optical displays having an in-plane drive electrode configuration and homeotropic arrangement of the liquid-crystal medium having positive dielectric anisotropy. The mixtures according to the invention are particularly preferably suitable for TN-TFT display applications having a low operating voltage, i.e. particularly preferably for notebook applications.

The liquid-crystal mixtures according to the invention enable a significant broadening of the available parameter latitude. The achievable combinations of clearing point, viscosity at low temperature, thermal and UV stability and high optical anisotropy are far superior to previous materials from the prior art.

The mixtures according to the invention are particularly suitable for mobile applications and high-Δn TFT applications, such as, for example, PDAs, notebooks, LCD TVs and monitors.

The liquid-crystal mixtures according to the invention, while retaining the nematic phase down to −20° C. and preferably down to −30° C., particularly preferably down to −40° C., and the clearing point ≧70° C., preferably ≧74° C., at the same time allow rotational viscosities γ₁ of ≦120 mPa·s, particularly preferably 60 mPa·s, to be achieved, enabling excellent MLC displays having fast response times to be achieved.

The dielectric anisotropy Δ∈ of the liquid-crystal mixtures according to the invention is preferably ≧+3, particularly preferably ≧+4. In addition, the mixtures are characterised by low operating voltages. The threshold voltage of the liquid-crystal mixtures according to the invention is preferably ≦2.5 V, in particular ≦2.2 V.

The birefringence Δn of the liquid-crystal mixtures according to the invention is preferably ≧0.08, in particular ≧0.10.

The nematic phase range of the liquid-crystal mixtures according to the invention preferably has a width of at least 90°, in particular at least 100°. This range preferably extends at least from −20° C. to +70° C.

If the mixtures according to the invention are used in IPS or FFS applications, the mixtures preferably have a dielectric anisotropy value of 3-20 and an optical anisotropy value of 0.07-0.13.

It goes without saying that, through a suitable choice of the components of the mixtures according to the invention, it is also possible for higher clearing points (for example above 100° C.) to be achieved at higher threshold voltages or lower clearing points to be achieved at lower threshold voltages with retention of the other advantageous properties. At viscosities correspondingly increased only slightly, it is likewise possible to obtain mixtures having higher A and thus low thresholds. The MLC displays according to the invention preferably operate at the first Gooch and Tarry transmission minimum [C. H. Gooch and H. A. Tarry, Electron. Lett. 10, 2-4, 1974; C. H. Gooch and H. A. Tarry, Appl. Phys., Vol. 8, 1575-1584, 1975], where, besides particularly favourable electro-optical properties, such as, for example, high steepness of the characteristic line and low angle dependence of the contrast (German patent 30 22 818), lower dielectric anisotropy is sufficient at the same threshold voltage as in an analogous display at the second minimum. This enables significantly higher specific resistance values to be achieved using the mixtures according to the invention at the first minimum than in the case of mixtures comprising cyano compounds. Through a suitable choice of the individual components and their proportions by weight, the person skilled in the art is able to set the birefringence necessary for a pre-specified layer thickness of the MLC display using simple routine methods.

The construction of the MLC display according to the invention from polarisers, electrode base plates and surface-treated electrodes corresponds to the usual design for displays of this type. The term usual design is broadly drawn here and also encompasses all derivatives and modifications of the MLC display, in particular including matrix display elements based on poly-Si TFTs or MIM.

A significant difference between the displays according to the invention and the hitherto conventional displays based on the twisted nematic cell consists, however, in the choice of the liquid-crystal parameters of the liquid-crystal layer.

The liquid-crystal mixtures which can be used in accordance with the invention are prepared in a manner conventional per se, for example by mixing one or more compounds of the formula I with one or more compounds of the formulae II-XXVII or with further liquid-crystalline compounds and/or additives. In general, the desired amount of the components used in the smaller amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing.

The dielectrics may also comprise further additives known to the person skilled in the art and described in the literature, such as, for example, UV stabilisers, such as Tinuvin® from Ciba Chemicals, in particular Tinuvin® 770, antioxidants, free-radical scavengers, nanoparticles, etc. For example, 0-15% of pleochroic dyes or chiral dopants can be added. Suitable stabilisers and dopants are mentioned below in Tables C and D.

In order to set the desired tilt angle, polymerizable compounds, so-called “reactive mesogens”, may also additionally be added to the mixtures according to the invention. Preferred polymerizable compounds are listed in Table E.

In the present application and in the examples below, the structures of the liquid-crystal compounds are indicated by means of acronyms, the trans-formation into chemical formulae taking place in accordance with Table A. All radicals CₙH₂ₙ₊₁ and CₘH₂ₘ₊₁ are straight-chain alkyl radicals having n and m C atoms respectively; n, m and k are integers and preferably denote 0, 1, 2, 3, 4, 5, 6, 7, 8, 9, 10, 11 or 12. The coding in Table B is self-evident. In Table A, only the acronym for the parent structure is indicated. In individual cases, the acronym for the parent structure is followed, separated by a dash, by a code for the substituents R¹*, R²*, L¹* and L²*:

| Code for R¹*, | | | | |
|---|---|---|---|---|
| R²*, L¹*, L²*, L³* | R¹* | R²* | L¹* | L²* |
| nm | CₙH₂ₙ₊₁ | CₘH₂ₘ₊₁ | H | H |
| nOm | CₙH₂ₙ₊₁ | OCₘH₂ₘ₊₁ | H | H |
| nO.m | OCₙH₂ₙ₊₁ | CₘH₂ₘ₊₁ | H | H |
| n | CₙH₂ₙ₊₁ | CN | H | H |
| nN.F | CₙH₂ₙ₊₁ | CN | F | H |
| nN.F.F | CₙH₂ₙ₊₁ | CN | F | F |
| nF | CₙH₂ₙ₊₁ | F | H | H |
| nCl | CₙH₂ₙ₊₁ | Cl | H | H |
| nOF | OCₙH₂ₙ₊₁ | F | H | H |
| nF.F | CₙH₂ₙ₊₁ | F | F | H |
| nF.F.F | CₙH₂ₙ₊₁ | F | F | F |
| nOCF₃ | CₙH₂ₙ₊₁ | OCF₃ | H | H |
| nOCF₃.F | CₙH₂ₙ₊₁ | OCF₃ | F | H |
| n-Vm | CₙH₂ₙ₊₁ | —CH═CH—CₘH₂ₘ₊₁ | H | H |
| nV-Vm | CₙH₂ₙ₊₁—CH═CH— | —CH═CH—CₘH₂ₘ₊₁ | H | H |

Preferred mixture components are shown in Tables A and B.

```
TABLE A
  PYP
  PYRP
  BCH
  CBC
  CCH
  CCP
  CPTP
  CEPTP
  ECCP
  CECP
  EPCH
  PCH
  CH
  PTP
  CCPC
  CP
  BECH
  EBCH
  CPC
  B
  FET-nF
  CGG
  CGU
  CFU
```

```
TABLE B
  APU-n-OXF
  ACQU-n-F
  APUQU-n-F
  BCH-n.Fm
  CFU-n-F
  CBC-nmF
  ECCP-nm
  CCZU-n-F
  PGP-n-m
  CGU-n-F
  CPU-n-VT
  CPU-n-AT
  CDUQU-n-F
  DGUQU-n-F
  CDU-n-F
  DCU-n-F
  C-n-V
  C-n-XF
  C-n-m
  Y-nO-Om
  CGG-n-F
  CPZG-n-OT
  CC-nV-Vm
  CPU-n-OXF
  CCP-Vn-m
  CCG-V-F
  CCP-nV-m
  CC-n-V
  CC-n-2V1
  CC-n-V1
  CCVC-n-V
  CCQU-n-F
  CC-n-Vm
  CLUQU-n-F
  CPPC-nV-Vm
  CCQG-n-F
  CQU-n-F
  Dec-U-n-F
  CWCU-n-F
  CPGP-n-m
  CWCG-n-F
  CCOC-n-m
  CPTU-n-F
  GPTU-n-F
  PQU-n-F
  PUQU-n-F
  PGU-n-F
  CGZP-n-OT
  CCGU-n-F
  CCQG-n-F
  DPGU-n-F
  DPGU-n-OT
  CUQU-n-F
  PPQU-n-F
  CCCQU-n-F
  CPPQU-n-F
  CGUQU-n-F
  CPGU-n-OT
  CCPU-n-F
  CCP-nOCF₃
  CPGU-n-F
  CVCP-1V-OT
  GGP-n-Cl
  PYP-nF
  PP-nV-Vm
  PP-1-nVm
  CWCQU-n-F
  PPGU-n-F
  PGUQU-n-F
  GPQU-n-F
  MPP-n-F
  MUQU-n-F
  NUQU-n-F
  PGP-n-kVm
  PP-n-kVm
  PCH-nCl
  GP-n-Cl
  GGP-n-F
  PGIGI-n-F
  PGU-n-OXF
(n = 1-15; (O)CₙH₂ₙ₊₁ means CₙH₂ₙ₊₁ or OCₙH₂ₙ₊₁)
```

Particular preference is given to liquid-crystalline mixtures which, besides the compounds of the formula I, comprise at least one, two, three, four or more compounds from Table B.

```
TABLE C
Table C indicates possible dopants which are generally added to the mixtures
according to the invention. The mixtures preferably comprise 0-10% by
weight, in particular 0.01-5% by weight and particularly preferably 0.01-3%
by weight, of dopants.
  C 15
  CB 15
  CM 21
  R/S-811
  CM 44
  CM 45
  CM 47
  CN
  R/S-2011
  R/S-3011
  R/S-4011
  R/S-5011
  R/S-1011
```

TABLE D
Stabilisers which can be added, for example, to the mixtures according to the
invention in amounts of 0-10% by weight are mentioned below.

TABLE E
Table E shows illustrative compounds which can be used in the LC media in
accordance with the present invention, preferably as reactive mesogenic
compounds. If the mixtures according to the invention comprise one or more
reactive compounds, they are preferably employed in amounts of 0.01-5% by
weight. It may be necessary to add an initiator or a mixture of two or more
initiators for the polymerisation. The initiator or initiator mixture is preferably
added in amounts of 0.001-2% by weight, based on the mixture. A suitable
initiator is, for example, Irgacure (BASF) or Irganox (BASF).

| | |
|---|---|
| | RM-1 |
| | RM-2 |
| | RM-3 |
| | RM-4 |
| | RM-5 |
| | RM-6 |
| | RM-7 |
| | RM-8 |
| | RM-9 |
| | RM-10 |
| | RM-11 |
| | RM-12 |
| | RM-13 |
| | RM-14 |
| | RM-15 |
| | RM-16 |
| | RM-17 |
| | RM-18 |
| | RM-19 |
| | RM-20 |
| | RM-21 |
| | RM-22 |
| | RM-23 |
| | RM-24 |
| | RM-25 |
| | RM-26 |
| | RM-27 |
| | RM-28 |
| | RM-29 |
| | RM-30 |
| | RM-31 |
| | RM-32 |
| | RM-33 |
| | RM-34 |
| | RM-35 |
| | RM-36 |
| | RM-37 |
| | RM-38 |
| | RM-39 |
| | RM-40 |
| | RM-41 |
| | RM-42 |
| | RM-43 |
| | RM-44 |
| | RM-45 |
| | RM-46 |
| | RM-47 |
| | RM-48 |
| | RM-49 |
| | RM-50 |
| | RM-51 |
| | RM-52 |
| | RM-53 |
| | RM-54 |
| | RM-55 |
| | RM-56 |
| | RM-57 |
| | RM-58 |
| | RM-59 |
| | RM-60 |
| | RM-61 |
| | RM-62 |
| | RM-63 |
| | RM-64 |
| | RM-65 |
| | RM-66 |
| | RM-67 |
| | RM-68 |
| | RM-69 |
| | RM-70 |
| | RM-71 |
| | RM-72 |
| | RM-73 |
| | RM-74 |
| | RM-75 |
| | RM-76 |
| | RM-77 |
| | RM-78 |
| | RM-79 |
| | RM-80 |
| | RM-81 |
| | RM-82 |
| | RM-83 |

In a preferred embodiment, the mixtures according to the invention comprise one or more polymerizable compounds, preferably selected from the polymerizable compounds of the formulae RM-1 to RM-83. Media of this type are particularly suitable for PS-FFS and PS-IPS applications. Of the reactive mesogens mentioned in Table E, compounds RM-1, RM-2, RM-3, RM-4, RM-5, RM-11, RM-17, RM-35, RM-41, RM-61 and RM-80 are particularly preferred.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding application No. U.S. 61/714,900, filed Oct. 17, 2012, and EP Application Serial No. 12006203.9, filed Aug. 31, 2012, are incorporated by reference herein.

m.p. denotes melting point, cl.p.=clearing point. Furthermore, C=crystalline state, N=nematic phase, S=smectic phase and I=isotropic phase. The data between these symbols represent the transition temperatures. Furthermore,
Vₒ denotes threshold voltage, capacitive [V] at 20° C.
Δn denotes the optical anisotropy measured at 20° C. and 589 nm
Δ∈ denotes the dielectric anisotropy at 20° C. and 1 kHz
cp. denotes clearing point [° C.]
K₁ denotes elastic constant, “splay” deformation at 20° C., [pN]
K₃ denotes elastic constant, “bend” deformation at 20° C., [pN]
γ₁ denotes rotational viscosity measured at 20° C. [mPa·s], determined by the rotation method in a magnetic field
LTS denotes low-temperature stability (nematic phase), determined in test cells.

### EXAMPLES

### Synthesis Examples

“Conventional work-up” means: water is added if necessary, the mixture is extracted with methylene chloride, diethyl ether, methyl tert-butyl ether or toluene, the phases are separated, the organic phase is dried and evaporated, and the product is purified by distillation under reduced pressure or crystallisation and/or chromatography.

### Example 1

The compound of the formula

is prepared in accordance with the following scheme:

C 43 S_{B} 75 N 96.2 I; Δn=0.0594; Δ∈=0.1; γ₁=43 mPa·s;

K₁=15.78; K₃=19.56

The following compounds

are prepared analogously.

### Mixture Examples

The electro-optical data are measured in a TN cell at the 1st minimum (i.e. at a d·Δn value of 0.5 μm) at 20° C., unless expressly indicated otherwise. The optical data are measured at 20° C., unless expressly indicated otherwise. All physical properties are determined in accordance with “Merck Liquid Crystals, Physical Properties of Liquid Crystals” Status November 1997, Merck KGaA, Germany, and apply to a temperature of 20° C., unless explicitly indicated otherwise.

### Example M1

| | | | |
|---|---|---|---|
| CC-3-V | 33.50% | Clearing point [° C.]: | 87.5 |
| CC-3-V1 | 10.00% | S → N transition: | −22° C. |
| CC-3-2V1 | 11.00% | Δn [589 nm, 20° C.] | 0.1087 |
| CCP-V2-1 | 2.00% | Δε [kHz, 20° C.]: | +15.4 |
| APUQU-2-F | 8.00% | γ₁ [mPa · s, 20° C.]: | 92 |
| APUQU-3-F | 8.00% | K₁ [20° C.]: | 14.5 |
| PGUQU-3-F | 2.50% | K₃ [20° C.]: | 15.9 |
| PGUQU-4-F | 6.00% | V₀ [V]: | 1.03 |
| PGUQU-5-F | 6.00% | | |
| DPGU-4-F | 7.00% | | |
| DGUQU-4-F | 6.00% | | |

### Example 2

For the preparation of a PS-IPS mixture, 0.25% of compound RM-1

is added to mixture M1.

### Example M3

| | | | |
|---|---|---|---|
| CC-3-V | 34.00% | Clearing point [° C.]: | 86.5 |
| CC-3-V1 | 9.00% | S → N transition: | −23° C. |
| CC-3-2V1 | 11.00% | Δn [589 nm, 20° C.] | 0.1088 |
| PP-1-2V1 | 1.00% | Δε [kHz, 20° C.]: | +15.3 |
| CCP-V2-1 | 1.50% | γ₁ [mPa · s, 20° C.]: | 92 |
| APUQU-2-F | 3.00% | K₁ [pN, 20° C.]: | 14.4 |
| APUQU-3-F | 7.00% | K₃ [pN, 20° C.]: | 16.1 |
| CDUQU-3-F | 3.00% | V₀ [V]: | 1.02 |
| PGUQU-3-F | 3.00% | | |
| PGUQU-4-F | 7.00% | | |
| PGUQU-5-F | 6.00% | | |
| DPGU-4-F | 7.00% | | |
| DGUQU-4-F | 7.50% | | |

### Example M4

For the preparation of a PS-FFS mixture, 0.3% of compound RM-41

is added to mixture M3.

### Example M5

| | | | |
|---|---|---|---|
| CC-3-V | 33.00% | Clearing point [° C.]: | 88.0 |
| CC-3-V1 | 10.50% | S → N transition: | −22° C. |
| CC-3-2V1 | 11.00% | Δn [589 nm, 20° C.] | 0.1096 |
| CCP-V2-1 | 2.00% | Δε [kHz, 20° C.]: | +15.3 |
| APUQU-2-F | 8.00% | γ₁ [mPa · s, 20° C.]: | 92 |
| APUQU-3-F | 8.00% | K₁ [pN, 20° C.]: | 14.7 |
| PGUQU-3-F | 3.00% | K₃ [pN, 20° C.]: | 16.2 |
| PGUQU-4-F | 6.00% | V₀ [V]: | 1.04 |
| PGUQU-5-F | 6.00% | | |
| DPGU-4-F | 7.00% | | |
| DGUQU-4-F | 5.50% | | |

### Example M6

For the preparation of a PS-FFS mixture, 0.25% of compound RM-1

is added to mixture M5.

### Example M7

For the preparation of a PS-IPS mixture, 0.25% of compound RM-17

is added to mixture M5.

### Example M8

| | | | |
|---|---|---|---|
| CC-3-V | 30.00% | Clearing point [° C.]: | 90.5 |
| CC-3-V1 | 10.00% | Δn [589 nm, 20° C.] | 0.1115 |
| PGP-2-2V | 3.00% | Δε [kHz, 20° C.]: | +19.5 |
| APUQU-2-F | 10.00% | γ₁ [mPa · s, 20° C.]: | 110 |
| APUQU-3-F | 9.00% | K₁ [pN, 20° C.]: | 14.7 |
| PGUQU-4-F | 7.00% | K₃ [pN, 20° C.]: | 16.0 |
| DGUQU-4-F | 8.00% | V₀ [V]: | 0.92 |
| CDUQU-3-F | 10.00% | | |
| DPGU-4-F | 6.00% | | |
| CC-3-2V1 | 7.00% | | |

### Example M9

For the preparation of a PS-FFS mixture, 0.25% of compound RM-1

is added to mixture M8.

### Example M10

For the preparation of a PS-FFS mixture, 0.2% of compound RM-61

is added to mixture M8.

### Example M11

| | | | |
|---|---|---|---|
| CC-3-V | 24.50% | Clearing point [° C.]: | 90.5 |
| CCP-V-1 | 17.00% | Δn [589 nm, 20° C.] | 0.1226 |
| PP-1-2V1 | 4.50% | Δε [kHz, 20° C.]: | +13.5 |
| PUQU-3-F | 9.00% | γ₁ [mPa · s, 20° C.]: | 103 |
| APUQU-3-F | 13.00% | K₁ [pN, 20° C.]: | 14.6 |
| PGUQU-3-F | 5.50% | K₃ [pN, 20° C.]: | 17.4 |
| PGUQU-4-F | 6.00% | V₀ [V]: | 1.09 |
| PGUQU-5-F | 6.00% | | |
| CCGU-3-F | 4.50% | | |
| CC-3-2V1 | 10.00% | | |

### Example M12

For the preparation of a PS-FFS mixture, 0.25% of compound RM-1

is added to mixture M11.

### Example M13

For the preparation of a PS-IPS mixture, 0.3% of compound RM-80

is added to mixture M11.

### Example M12

| | | | |
|---|---|---|---|
| CC-3-V | 31.00% | Clearing point [° C.]: | 80.0 |
| CC-3-V1 | 9.00% | S → N transition: | −22.5° C. |
| CC-3-2V1 | 9.00% | Δn [589 nm, 20° C.] | 0.1088 |
| CCP-V2-1 | 2.00% | Δε [kHz, 20° C.]: | +11.8 |
| PP-1-2V1 | 9.00% | γ₁ [mPa · s, 20° C.]: | 80 |
| CCGU-3-F | 3.00% | LTS bulk −20° C.: | >1000 h |
| APUQU-2-F | 9.00% | K₁ [pN, 20° C.]: | 14.8 |
| APUQU-3-F | 9.00% | K₃ [pN, 20° C.]: | 16.2 |
| PGUQU-3-F | 4.00% | V₀ [V]: | 1.18 |
| PGUQU-4-F | 7.00% | | |
| CDUQU-3-F | 8.00% | | |

### Example M12

For the preparation of a PS-IPS mixture, 0.25% of compound RM-17

is added to mixture M12.

### Example M13

| | | | |
|---|---|---|---|
| CC-3-V | 31.00% | Clearing point [° C.]: | 82.5 |
| CC-3-V1 | 9.00% | Δn [589 nm, 20° C.] | 0.1097 |
| CC-3-2V1 | 9.00% | Δε [kHz, 20° C.]: | +12.7 |
| CCP-V2-1 | 2.00% | γ₁ [mPa · s, 20° C.]: | 85 |
| PP-1-2V1 | 7.00% | LTS bulk −20° C.: | >1000 h |
| CCGU-3-F | 3.00% | K₁ [pN, 20° C.]: | 14.8 |
| APUQU-2-F | 9.00% | K₃ [pN, 20° C.]: | 16.6 |
| APUQU-3-F | 9.00% | V₀ [V]: | 1.13 |
| PGUQU-3-F | 3.00% | | |
| PGUQU-4-F | 7.00% | | |
| PGUQU-5-F | 3.00% | | |
| CDUQU-3-F | 8.00% | | |

### Example M14

For the preparation of a PS-FFS mixture, 0.25% of compound RM-1

is added to mixture M13.

### Example M15

| | | | |
|---|---|---|---|
| CC-3-V | 29.50% | Clearing point [° C.]: | 85.5 |
| CC-3-V1 | 12.00% | Δn [589 nm, 20° C.] | 0.1092 |
| CC-3-2V1 | 9.00% | Δε [kHz, 20° C.]: | +15.8 |
| PP-1-2V1 | 2.00% | γ₁ [mPa · s, 20° C.]: | 91 |
| CCP-3OCF₃ | 5.00% | K₁ [pN, 20° C.]: | 14.7 |
| PUQU-3-F | 1.00% | K₃ [pN, 20° C.]: | 15.5 |
| APUQU-2-F | 7.00% | V₀ [V]: | 1.01 |
| APUQU-3-F | 9.00% | | |
| PGUQU-3-F | 3.50% | | |
| PGUQU-4-F | 9.00% | | |
| DPGU-4-F | 5.00% | | |
| DGUQU-4-F | 8.00% | | |

### Example M16

| | | | |
|---|---|---|---|
| CC-3-V | 31.00% | Clearing point [° C.]: | 88 |
| CC-2-2V1 | 10.00% | Δn [589 nm, 20° C.] | 0.1082 |
| CC-3-V1 | 10.00% | Δε [kHz, 20° C.]: | +15.5 |
| CCP-V2-1 | 6.00% | γ₁ [mPa · s, 20° C.]: | 95 |
| APUQU-2-F | 8.00% | K₁ [pN, 20° C.]: | 14.4 |
| APUQU-3-F | 8.00% | K₃ [pN, 20° C.]: | 15.2 |
| PGUQU-3-F | 3.00% | V₀ [V]: | 1.02 |
| PGUQU-4-F | 6.00% | | |
| PGUQU-5-F | 3.00% | | |
| DPGU-4-F | 7.00% | | |
| DGUQU-4-F | 8.00% | | |

### Example M17

| | | | |
|---|---|---|---|
| APUQU-2-F | 7.00% | Clearing point [° C.]: | 79 |
| APUQU-3-F | 6.00% | Δn [589 nm, 20° C.] | 0.1090 |
| CC-3-V | 41.00% | Δε [kHz, 20° C.]: | +10.4 |
| CC-4-2V1 | 7.00% | γ₁ [mPa · s, 20° C.]: | 71 |
| CCP-V-1 | 12.00% | K₁ [pN, 20° C.]: | 12.3 |
| PGP-2-2V | 4.00% | K₃ [pN, 20° C.]: | 14.0 |
| PGUQU-3-F | 8.00% | V₀ [V]: | 1.15 |
| PGUQU-4-F | 8.00% | | |
| PUQU-3-F | 7.00% | | |

### Example M18

For the preparation of a PS-FFS mixture, 0.25% of compound RM-1

is added to mixture M17.

### Example M19

| | | | |
|---|---|---|---|
| CC-3-V | 35.00% | Clearing point [° C.]: | 75.5 |
| PGU-2-F | 6.00% | Δn [589 nm, 20° C.] | 0.1165 |
| APUQU-2-F | 7.00% | Δε [kHz, 20° C.]: | +8.3 |
| APUQU-3-F | 11.00% | γ₁ [mPa · s, 20° C.]: | 64 |
| PGUQU-3-F | 4.00% | K₁ [pN, 20° C.]: | 15.3 |
| PP-1-2V1 | 10.00% | K₃ [pN, 20° C.]: | 14.3 |
| PGP-2-2V | 6.00% | V₀ [V]: | 1.44 |
| CCP-3OCF₃ | 10.00% | | |
| CC-3-2V1 | 11.00% | | |

### Example M20

| | | | |
|---|---|---|---|
| CC-3-V | 33.00% | Clearing point [° C.]: | 89.0 |
| CC-3-V1 | 9.00% | Δn [589 nm, 20° C.] | 0.1092 |
| CC-3-2V1 | 11.00% | Δε [kHz, 20° C.]: | +16.1 |
| CCP-V2-1 | 2.00% | γ₁ [mPa · s, 20° C.]: | 96 |
| APUQU-2-F | 2.00% | K₁ [pN, 20° C.]: | 14.6 |
| APUQU-3-F | 6.00% | K₃ [pN, 20° C.]: | 16.3 |
| PGUQU-3-F | 3.00% | V₀ [V]: | 1.01 |
| PGUQU-4-F | 7.00% | | |
| PGUQU-5-F | 7.00% | | |
| DPGU-4-F | 7.00% | | |
| CDUQU-3-F | 5.00% | | |
| DGUQU-4-F | 8.00% | | |

### Example M21

| | | | |
|---|---|---|---|
| CC-3-V | 32.50% | Clearing point [° C.]: | 87.0 |
| CC-3-V1 | 8.00% | Δn [589 nm, 20° C.] | 0.1093 |
| CC-3-2V1 | 11.00% | Δε [kHz, 20° C.]: | +15.6 |
| CCP-3OCF₃ | 5.00% | γ₁ [mPa · s, 20° C.]: | 92 |
| APUQU-2-F | 8.00% | K₁ [pN, 20° C.]: | 14.6 |
| APUQU-3-F | 7.00% | K₃ [pN, 20° C.]: | 15.3 |
| PGUQU-3-F | 3.00% | V₀ [V]: | 1.02 |
| PGUQU-4-F | 6.00% | | |
| PGUQU-5-F | 5.00% | | |
| DPGU-4-F | 7.00% | | |
| DGUQU-4-F | 5.50% | | |
| PUQU-3-F | 2.00% | | |

### Example M22

| | | | |
|---|---|---|---|
| CC-3-V | 32.00% | Clearing point [° C.]: | 87.0 |
| CC-3-V1 | 8.00% | Δn [589 nm, 20° C.] | 0.1082 |
| CC-3-2V1 | 11.00% | Δε [kHz, 20° C.]: | +14.9 |
| CCP-3OCF₃ | 7.00% | γ₁ [mPa · s, 20° C.]: | 90 |
| APUQU-2-F | 6.00% | K₁ [pN, 20° C.]: | 14.7 |
| APUQU-3-F | 7.00% | K₃ [pN, 20° C.]: | 15.5 |
| PGUQU-3-F | 3.00% | V₀ [V]: | 1.05 |
| PGUQU-4-F | 6.00% | | |
| PGUQU-5-F | 5.00% | | |
| DPGU-4-F | 7.00% | | |
| DGUQU-4-F | 5.50% | | |
| PUQU-3-F | 2.50% | | |

### Example M23

| | | | |
|---|---|---|---|
| CC-3-V | 33.00% | Clearing point [° C.]: | 86.5 |
| CC-3-V1 | 11.00% | Δn [589 nm, 20° C.] | 0.1091 |
| CC-3-2V1 | 11.00% | Δε [kHz, 20° C.]: | +15.7 |
| PGP-2-2V | 2.00% | γ₁ [mPa · s, 20° C.]: | 90 |
| APUQU-2-F | 10.00% | K₁ [pN, 20° C.]: | 14.7 |
| APUQU-3-F | 7.00% | K₃ [pN, 20° C.]: | 15.3 |
| PGUQU-3-F | 5.00% | V₀ [V]: | 1.02 |
| PGUQU-4-F | 4.00% | | |
| PGUQU-5-F | 2.00% | | |
| DPGU-4-F | 7.00% | | |
| DGUQU-4-F | 8.00% | | |

### Example M24

| | | | |
|---|---|---|---|
| CC-3-V | 31.50% | Clearing point [° C.]: | 88.0 |
| CC-3-V1 | 7.50% | Δn [589 nm, 20° C.] | 0.1077 |
| CC-3-2V1 | 12.00% | Δε [kHz, 20° C.]: | +15.2 |
| CCP-V2-1 | 1.00% | γ₁ [mPa · s, 20° C.]: | 93 |
| CCP-3OCF₃ | 5.50% | K₁ [pN, 20° C.]: | 14.8 |
| APUQU-3-F | 3.00% | K₃ [pN, 20° C.]: | 15.8 |
| PGUQU-3-F | 4.00% | V₀ [V]: | 1.04 |
| PGUQU-4-F | 8.00% | | |
| PGUQU-5-F | 5.00% | | |
| DPGU-4-F | 7.00% | | |
| DGUQU-4-F | 8.00% | | |
| PUQU-3-F | 3.00% | | |
| CDUQU-3-F | 4.50% | | |

### Example M25

| | | | |
|---|---|---|---|
| CC-3-V | 31.50% | Clearing point [° C.]: | 87.5 |
| CC-3-V1 | 7.50% | Δn [589 nm, 20° C.] | 0.1083 |
| CC-3-2V1 | 12.00% | Δε [kHz, 20° C.]: | +15.6 |
| CCP-V2-1 | 1.00% | γ₁ [mPa · s, 20° C.]: | 93 |
| CCP-3OCF₃ | 4.50% | K₁ [pN, 20° C.]: | 14.8 |
| APUQU-3-F | 4.00% | K₃ [pN, 20° C.]: | 15.7 |
| PGUQU-3-F | 4.00% | V₀ [V]: | 1.03 |
| PGUQU-4-F | 8.00% | | |
| PGUQU-5-F | 5.00% | | |
| DPGU-4-F | 7.00% | | |
| DGUQU-4-F | 8.00% | | |
| PUQU-3-F | 3.00% | | |
| CDUQU-3-F | 4.50% | | |

### Example M26

| | | | |
|---|---|---|---|
| CC-3-V | 32.50% | Clearing point [° C.]: | 84.0 |
| CC-3-V1 | 7.50% | Δn [589 nm, 20° C.] | 0.1096 |
| CC-3-2V1 | 11.00% | Δε [kHz, 20° C.]: | +16.0 |
| PP-1-2V1 | 1.50% | γ₁ [mPa · s, 20° C.]: | 89 |
| CCP-V2-1 | 1.00% | K₁ [pN, 20° C.]: | 14.3 |
| CCP-3OCF₃ | 3.00% | K₃ [pN, 20° C.]: | 15.1 |
| APUQU-2-F | 7.00% | V₀ [V]: | 1.00 |
| APUQU-3-F | 7.50% | | |
| PGUQU-3-F | 3.50% | | |
| PGUQU-4-F | 7.00% | | |
| PGUQU-5-F | 1.50% | | |
| DPGU-4-F | 6.50% | | |
| DGUQU-4-F | 8.00% | | |
| PUQU-3-F | 2.50% | | |

### Example M27

| | | | |
|---|---|---|---|
| CC-3-V | 32.50% | Clearing point [° C.]: | 84.0 |
| CC-3-V1 | 8.00% | Δn [589 nm, 20° C.] | 0.1089 |
| CC-3-2V1 | 11.00% | Δε [kHz, 20° C.]: | +16.1 |
| PP-1-2V1 | 1.50% | γ₁ [mPa · s, 20° C.]: | 90 |
| CCP-3OCF₃ | 3.50% | K₁ [pN, 20° C.]: | 14.3 |
| APUQU-2-F | 7.00% | K₃ [pN, 20° C.]: | 14.9 |
| APUQU-3-F | 8.00% | V₀ [V]: | 1.00 |
| PGUQU-3-F | 3.50% | | |
| PGUQU-4-F | 7.00% | | |
| PGUQU-5-F | 1.50% | | |
| DPGU-4-F | 6.50% | | |
| DGUQU-4-F | 8.00% | | |
| PUQU-3-F | 2.00% | | |

### Example M28

| | | | |
|---|---|---|---|
| CC-3-V | 30.00% | Clearing point [° C.]: | 85.5 |
| CC-3-V1 | 7.00% | Δn [589 nm, 20° C.] | 0.1127 |
| CC-3-2V1 | 11.50% | Δε [kHz, 20° C.]: | +17.8 |
| CCP-3OCF₃ | 4.50% | γ₁ [mPa · s, 20° C.]: | 95 |
| APUQU-2-F | 8.00% | K₁ [pN, 20° C.]: | 14.4 |
| APUQU-3-F | 8.00% | K₃ [pN, 20° C.]: | 14.7 |
| PGUQU-3-F | 3.00% | V₀ [V]: | 0.95 |
| PGUQU-4-F | 7.00% | | |
| DPGU-4-F | 7.00% | | |
| DGUQU-4-F | 8.00% | | |
| PUQU-3-F | 2.50% | | |
| PGU-3-F | 3.50% | | |

### Example M29

| | | | |
|---|---|---|---|
| CC-3-V | 31.50% | Clearing point [° C.]: | 87.0 |
| CC-3-V1 | 8.00% | Δn [589 nm, 20° C.] | 0.1090 |
| CC-3-2V1 | 11.00% | Δε [kHz, 20° C.]: | +17.5 |
| CCP-3OCF₃ | 3.00% | γ₁ [mPa · s, 20° C.]: | 96 |
| APUQU-2-F | 7.00% | K₁ [pN, 20° C.]: | 14.4 |
| APUQU-3-F | 8.00% | K₃ [pN, 20° C.]: | 15.2 |
| PGUQU-3-F | 3.50% | V₀ [V]: | 0.96 |
| PGUQU-4-F | 7.00% | | |
| CDUQU-3-F | 3.00% | | |
| DPGU-4-F | 6.50% | | |
| DGUQU-4-F | 8.00% | | |
| PPGU-3-F | 1.00% | | |
| PUQU-3-F | 2.50% | | |

### Example M30

| | | | |
|---|---|---|---|
| CC-3-V | 31.00% | Clearing point [° C.]: | 86.0 |
| CC-3-V1 | 7.50% | Δn [589 nm, 20° C.] | 0.1083 |
| CC-3-2V1 | 10.50% | Δε [kHz, 20° C.]: | +17.4 |
| CCP-3OCF₃ | 7.50% | γ₁ [mPa · s, 20° C.]: | 92 |
| APUQU-2-F | 5.00% | K₁ [pN, 20° C.]: | 14.5 |
| APUQU-3-F | 4.50% | K₃ [pN, 20° C.]: | 14.7 |
| PGUQU-3-F | 4.00% | V₀ [V]: | 0.96 |
| PGUQU-4-F | 8.00% | | |
| DPGU-4-F | 7.00% | | |
| DGUQU-4-F | 7.50% | | |
| DGUQU-2-F | 4.00% | | |
| PUQU-3-F | 3.50% | | |

### Example M31

| | | | |
|---|---|---|---|
| APUQU-2-F | 8.00% | Clearing point [° C.]: | 84.0 |
| APUQU-3-F | 5.00% | Δn [589 nm, 20° C.] | 0.1090 |
| CC-3-2V1 | 12.00% | Δε [kHz, 20° C.]: | +17.4 |
| CC-3-V | 32.00% | γ₁ [mPa · s, 20° C.]: | 91 |
| CC-3-V1 | 10.00% | K₁ [pN, 20° C.]: | 14.1 |
| DGUQU-4-F | 10.00% | K₃ [pN, 20° C.]: | 14.8 |
| DPGU-4-F | 8.00% | V₀ [V]: | 0.95 |
| PGUQU-3-F | 5.00% | | |
| PGUQU-4-F | 8.00% | | |
| PUQU-3-F | 1.50% | | |
| Y-4O-O4 | 0.50% | | |

### Example M32

| | | | |
|---|---|---|---|
| CC-3-V | 26.50% | Clearing point [° C.]: | 85.5 |
| CC-3-V1 | 9.00% | Δn [589 nm, 20° C.] | 0.1209 |
| CC-3-2V1 | 11.00% | Δε [kHz, 20° C.]: | +4.1 |
| CCP-V-1 | 14.00% | γ₁ [mPa · s, 20° C.]: | 64 |
| PGP-1-2V | 4.50% | K₁ [pN, 20° C.]: | 15.8 |
| PGP-2-2V | 12.00% | K₃ [pN, 20° C.]: | 16.5 |
| CCP-3OCF₃ | 3.00% | V₀ [V]: | 2.07 |
| PGUQU-3-F | 3.50% | | |
| DGUQU-4-F | 5.00% | | |
| PP-1-2V1 | 6.00% | | |
| PUQU-3-F | 5.50% | | |

### Example M33

| | | | |
|---|---|---|---|
| CC-3-V | 27.00% | Clearing point [° C.]: | 86.5 |
| CC-3-V1 | 11.00% | Δn [589 nm, 20° C.] | 0.1081 |
| CC-3-2V1 | 11.00% | Δε [kHz, 20° C.]: | +4.3 |
| CCP-V-1 | 12.00% | γ₁ [mPa · s, 20° C.]: | 64 |
| PGP-2-2V | 8.00% | K₁ [pN, 20° C.]: | 16.9 |
| CCP-3OCF₃ | 5.00% | K₃ [pN, 20° C.]: | 17.6 |
| PGUQU-3-F | 1.00% | V₀ [V]: | 2.09 |
| PGUQU-4-F | 2.50% | | |
| DPGU-4-F | 1.00% | | |
| APUQU-3-F | 3.00% | | |
| PP-1-2V1 | 10.50% | | |
| CDUQU-3-F | 8.00% | | |

### Example M34

| | | | |
|---|---|---|---|
| APUQU-2-F | 1.00% | Clearing point [° C.]: | 85.0 |
| CC-3-2V1 | 13.00% | Δn [589 nm, 20° C.] | 0.1242 |
| CC-3-V | 14.50% | Δε [kHz, 20° C.]: | +4.4 |
| CC-3-V1 | 12.00% | γ₁ [mPa · s, 20° C.]: | 68 |
| CCP-3OCF₃ | 5.50% | K₁ [pN, 20° C.]: | 19.7 |
| CCP-4OCF₃ | 1.00% | K₃ [pN, 20° C.]: | 18.5 |
| CCP-5OCF₃ | 1.50% | V₀ [V]: | 2.23 |
| CCP-V-1 | 11.00% | | |
| CCP-V2-1 | 2.50% | | |
| CPGU-3-OT | 0.50% | | |
| DPGU-4-F | 4.50% | | |
| PGP-1-2V | 1.00% | | |
| PGP-2-2V | 3.50% | | |
| PGU-2-F | 0.50% | | |
| PGU-3-F | 1.50% | | |
| PGUQU-3-F | 1.00% | | |
| PGUQU-5-F | 2.00% | | |
| PP-1-2V1 | 18.50% | | |
| PPGU-3-F | 0.50% | | |
| PUQU-3-F | 4.50% | | |

### Example M35

| | | | |
|---|---|---|---|
| CC-3-V | 29.50% | Clearing point [° C.]: | 90.0 |
| CC-3-V1 | 9.00% | Δn [589 nm, 20° C.] | 0.1085 |
| CC-3-2V1 | 10.50% | Δε [kHz, 20° C.]: | +15.9 |
| CCP-3OCF₃ | 6.50% | γ₁ [mPa · s, 20° C.]: | 95 |
| CCVC-3-V | 2.00% | K₁ [pN, 20° C.]: | 15.1 |
| PUQU-3-F | 3.50% | K₃ [pN, 20° C.]: | 15.8 |
| APUQU-2-F | 6.00% | V₀ [V]: | 1.03 |
| APUQU-3-F | 6.00% | | |
| PGUQU-3-F | 4.00% | | |
| PGUQU-4-F | 8.00% | | |
| DPGU-4-F | 7.00% | | |
| DGUQU-4-F | 8.00% | | |

### Example M36

| | | | |
|---|---|---|---|
| CC-3-V | 19.50% | Clearing point [° C.]: | 99.5 |
| CC-3-V1 | 10.00% | Δn [589 nm, 20° C.] | 0.1217 |
| CC-3-2V1 | 11.00% | Δε [kHz, 20° C.]: | +5.3 |
| CCP-V-1 | 12.00% | γ₁ [mPa · s, 20° C.]: | 83 |
| CCP-V2-1 | 5.00% | K₁ [pN, 20° C.]: | 19.5 |
| PGP-2-3 | 5.00% | K₃ [pN, 20° C.]: | 18.5 |
| PGP-2-2V | 7.00% | V₀ [V]: | 2.04 |
| CCP-3OCF₃ | 7.00% | | |
| PUQU-3-F | 4.00% | | |
| DGUQU-4-F | 6.00% | | |
| PP-1-2V1 | 6.00% | | |
| DPGU-4-F | 3.50% | | |
| CPGU-3-OT | 4.00% | | |

### Example M37

| | | | |
|---|---|---|---|
| CC-3-V | 18.50% | Clearing point [° C.]: | 98.0 |
| CC-3-V1 | 10.00% | Δn [589 nm, 20° C.] | 0.1225 |
| CC-3-2V1 | 11.00% | Δε [kHz, 20° C.]: | +5.2 |
| CCP-V-1 | 17.50% | γ₁ [mPa · s, 20° C.]: | 80 |
| PGP-2-2V | 13.00% | K₁ [pN, 20° C.]: | 18.2 |
| CCP-3OCF₃ | 6.50% | K₃ [pN, 20° C.]: | 18.0 |
| PUQU-3-F | 6.00% | V₀ [V]: | 1.99 |
| DGUQU-4-F | 6.00% | | |
| PP-1-2V1 | 5.50% | | |
| CPGU-3-OT | 6.00% | | |

### Example M38

| | | | |
|---|---|---|---|
| APUQU-3-F | 1.00% | Clearing point [° C.]: | 102.0 |
| CC-3-2V1 | 11.00% | Δn [589 nm, 20° C.] | 0.1219 |
| CC-3-V | 22.50% | Δε [kHz, 20° C.]: | +5.3 |
| CC-3-V1 | 8.00% | γ₁ [mPa · s, 20° C.]: | 82 |
| CCP-3OCF₃ | 5.00% | K₁ [pN, 20° C.]: | 18.8 |
| CCP-4OCF₃ | 3.50% | K₃ [pN, 20° C.]: | 18.1 |
| CCP-V-1 | 13.00% | V₀ [V]: | 1.99 |
| CCP-V2-1 | 4.00% | | |
| CPGU-3-OT | 3.50% | | |
| DPGU-4-F | 4.00% | | |
| PGP-1-2V | 3.50% | | |
| PGP-2-2V | 8.00% | | |
| PGU-2-F | 1.00% | | |
| PGU-3-F | 2.50% | | |
| PGUQU-3-F | 3.00% | | |
| PP-1-2V1 | 1.50% | | |
| PUQU-3-F | 5.00% | | |

### Example M39

| | | | |
|---|---|---|---|
| CC-3-V | 32.50% | Clearing point [° C.]: | 86.0 |
| CC-3-V1 | 8.50% | Δn [589 nm, 20° C.] | 0.1093 |
| CC-3-2V1 | 10.50% | Δε [kHz, 20° C.]: | +16.0 |
| PGP-2-3 | 1.00% | γ₁ [mPa · s, 20° C.]: | 91 |
| CCP-3OCF₃ | 4.50% | K₁ [pN, 20° C.]: | 14.4 |
| PUQU-3-F | 2.50% | K₃ [pN, 20° C.]: | 15.0 |
| APUQU-2-F | 7.00% | V₀ [V]: | 1.00 |
| APUQU-3-F | 6.50% | | |
| PGUQU-3-F | 4.00% | | |
| PGUQU-4-F | 8.00% | | |
| DPGU-4-F | 7.00% | | |
| DGUQU-4-F | 8.00% | | |

### Example M40

| | | | |
|---|---|---|---|
| CC-3-V | 30.00% | Clearing point [° C.]: | 85.5 |
| CC-3-V1 | 12.00% | Δn [589 nm, 20° C.] | 0.1088 |
| CC-3-2V1 | 9.00% | Δε [kHz, 20° C.]: | +15.9 |
| PGP-2-2V | 1.00% | γ₁ [mPa · s, 20° C.]: | 92 |
| CCP-3OCF₃ | 5.00% | K₁ [pN, 20° C.]: | 14.2 |
| PUQU-3-F | 2.00% | K₃ [pN, 20° C.]: | 15.5 |
| APUQU-2-F | 8.00% | V₀ [V]: | 0.99 |
| APUQU-3-F | 7.00% | | |
| PGUQU-3-F | 3.00% | | |
| PGUQU-4-F | 8.00% | | |
| PGUQU-5-F | 3.00% | | |
| DPGU-4-F | 4.00% | | |
| DGUQU-4-F | 8.00% | | |

### Example M41

| | | | |
|---|---|---|---|
| CC-3-V | 43.50% | Clearing point [° C.]: | 80.9 |
| CC-3-V1 | 5.50% | Δn [589 nm, 20° C.] | 0.1080 |
| CCP-V-1 | 3.50% | Δε [kHz, 20° C.]: | +9.1 |
| APUQU-3-F | 11.00% | γ₁ [mPa · s, 20° C.]: | 66 |
| PGUQU-3-F | 6.00% | K₁ [pN, 20° C.]: | 14.0 |
| PGUQU-4-F | 6.50% | K₃ [pN, 20° C.]: | 14.5 |
| PGU-2-F | 5.00% | V₀ [V]: | 1.30 |
| DPGU-4-F | 5.00% | | |
| PGP-1-2V | 3.50% | | |
| PPGU-3-F | 0.50% | | |
| CC-3-2V1 | 10.00% | | |

### Example M42

| | | | |
|---|---|---|---|
| CC-3-V | 45.00% | Clearing point [° C.]: | 80.0 |
| CC-3-V1 | 10.00% | Δn [589 nm, 20° C.] | 0.1008 |
| CCP-V-1 | 6.50% | Δε [kHz, 20° C.]: | +4.2 |
| PGP-2-3 | 4.00% | γ₁ [mPa · s, 20° C.]: | 56 |
| PGP-2-4 | 5.00% | K₁ [pN, 20° C.]: | 14.2 |
| PGUQU-3-F | 6.50% | K₃ [pN, 20° C.]: | 15.9 |
| PGUQU-4-F | 7.00% | V₀ [V]: | 1.93 |
| PGUQU-5-F | 3.50% | | |
| CC-3-2V1 | 8.50% | | |
| CCP-V2-1 | 4.00% | | |

### Example M43

| | | | |
|---|---|---|---|
| CC-3-V | 29.50% | Clearing point [° C.]: | 95.5 |
| CC-3-V1 | 10.00% | Δn [589 nm, 20° C.] | 0.1213 |
| CC-3-2V1 | 10.00% | Δε [kHz, 20° C.]: | +4.5 |
| CCP-V-1 | 11.00% | γ₁ [mPa · s, 20° C.]: | 72 |
| CCP-V2-1 | 3.00% | K₁ [pN, 20° C.]: | 17.0 |
| PGP-2-3 | 5.00% | K₃ [pN, 20° C.]: | 17.8 |
| PGP-2-4 | 1.50% | V₀ [V]: | 2.04 |
| PGP-2-2V | 10.00% | | |
| CCP-3OCF₃ | 4.00% | | |
| PGUQU-3-F | 3.00% | | |
| PGUQU-4-F | 8.00% | | |
| PGUQU-5-F | 5.00% | | |

### Example M44

| | | | |
|---|---|---|---|
| CC-3-V | 27.50% | Clearing point [° C.]: | 103.5 |
| CC-3-V1 | 11.00% | Δn [589 nm, 20° C.] | 0.1183 |
| CC-3-2V1 | 10.00% | Δε [kHz, 20° C.]: | +4.7 |
| CCP-V-1 | 12.00% | γ₁ [mPa · s, 20° C.]: | 80 |
| CCP-V2-1 | 8.00% | K₁ [pN, 20° C.]: | 17.9 |
| PGP-2-3 | 2.50% | K₃ [pN, 20° C.]: | 19.4 |
| PGP-2-2V | 10.00% | V₀ [V]: | 2.05 |
| APUQU-3-F | 5.00% | | |
| PGUQU-3-F | 4.00% | | |
| PGUQU-4-F | 5.00% | | |
| CPGU-3-OT | 5.00% | | |

### Example M45

| | | | |
|---|---|---|---|
| CC-3-V | 27.00% | Clearing point [° C.]: | 104.5 |
| CC-3-V1 | 10.00% | Δn [589 nm, 20° C.] | 0.1179 |
| CC-3-2V1 | 10.00% | Δε [kHz, 20° C.]: | +4.7 |
| CCP-V-1 | 12.00% | γ₁ [mPa · s, 20° C.]: | 81 |
| CCP-V2-1 | 8.00% | K₁ [pN, 20° C.]: | 18.3 |
| PGP-2-3 | 3.00% | K₃ [pN, 20° C.]: | 19.6 |
| PGP-2-2V | 10.00% | V₀ [V]: | 2.07 |
| CCP-3OCF₃ | 1.50% | | |
| APUQU-3-F | 7.00% | | |
| PGUQU-3-F | 4.00% | | |
| PGUQU-4-F | 3.00% | | |
| CPGU-3-OT | 4.50% | | |

### Example M46

| | | | |
|---|---|---|---|
| APUQU-3-F | 4.50% | Clearing point [° C.]: | 103.5 |
| CC-3-2V1 | 9.00% | Δn [589 nm, 20° C.] | 0.1175 |
| CC-3-V | 29.00% | Δε [kHz, 20° C.]: | +4.7 |
| CC-3-V1 | 11.00% | γ₁ [mPa · s, 20° C.]: | 80 |
| CCP-V-1 | 10.00% | K₁ [pN, 20° C.]: | 17.8 |
| CCP-V2-1 | 10.00% | K₃ [pN, 20° C.]: | 19.9 |
| CPGU-3-OT | 5.00% | V₀ [V]: | 2.04 |
| PGP-1-2V | 3.00% | | |
| PGP-2-2V | 6.00% | | |
| PGP-3-2V | 3.00% | | |
| PGUQU-3-F | 5.00% | | |
| PGUQU-4-F | 4.50% | | |

### Example M47

| | | | |
|---|---|---|---|
| CC-3-V | 20.50% | Clearing point [° C.]: | 109.0 |
| CC-3-V1 | 10.00% | Δn [589 nm, 20° C.] | 0.1189 |
| CC-3-2V1 | 10.00% | Δε [kHz, 20° C.]: | +5.4 |
| CCP-V-1 | 12.00% | γ₁ [mPa · s, 20° C.]: | 90 |
| CCP-V2-1 | 8.00% | K₁ [pN, 20° C.]: | 19.3 |
| PGP-2-2V | 10.50% | K₃ [pN, 20° C.]: | 20.9 |
| CCP-3OCF₃ | 8.50% | V₀ [V]: | 1.99 |
| CCP-5OCF₃ | 3.50% | | |
| PGUQU-3-F | 3.00% | | |
| PGUQU-4-F | 7.00% | | |
| PGUQU-5-F | 7.00% | | |

### Example M48

| | | | |
|---|---|---|---|
| CC-3-V | 26.50% | Clearing point [° C.]: | 103.0 |
| CC-3-V1 | 10.00% | Δn [589 nm, 20° C.] | 0.1200 |
| CC-3-2V1 | 10.00% | Δε [kHz, 20° C.]: | +4.6 |
| CCP-V-1 | 12.00% | γ₁ [mPa · s, 20° C.]: | 84 |
| CCP-V2-1 | 7.50% | K₁ [pN, 20° C.]: | 18.0 |
| PGP-2-3 | 5.00% | K₃ [pN, 20° C.]: | 18.7 |
| PGP-2-4 | 2.50% | V₀ [V]: | 2.07 |
| PGP-2-2V | 10.00% | | |
| APUQU-3-F | 1.50% | | |
| PGUQU-3-F | 2.00% | | |
| CPGU-3-OT | 5.00% | | |
| DGUQU-4-F | 8.00% | | |

### Example M49

| | | | |
|---|---|---|---|
| CC-3-V | 24.00% | Clearing point [° C.]: | 105.0 |
| CC-3-V1 | 10.50% | Δn [589 nm, 20° C.] | 0.1181 |
| CC-3-2V1 | 10.00% | Δε [kHz, 20° C.]: | +6.1 |
| CCP-V-1 | 12.00% | γ₁ [mPa · s, 20° C.]: | 89 |
| CCP-V2-1 | 10.00% | K₁ [pN, 20° C.]: | 17.8 |
| PGP-2-2V | 9.50% | K₃ [pN, 20° C.]: | 19.3 |
| PUQU-3-F | 2.00% | V₀ [V]: | 1.79 |
| APUQU-2-F | 3.00% | | |
| APUQU-3-F | 7.00% | | |
| PGUQU-3-F | 4.00% | | |
| PGUQU-4-F | 5.00% | | |
| CPGU-3-OT | 1.50% | | |
| CPGP-5-2 | 1.50% | | |

### Example M50

| | | | |
|---|---|---|---|
| CC-3-V | 23.00% | Clearing point [° C.]: | 105.0 |
| CC-3-V1 | 10.00% | Δn [589 nm, 20° C.] | 0.1180 |
| CC-3-2V1 | 10.00% | Δε [kHz, 20° C.]: | +6.2 |
| CCP-V-1 | 12.00% | γ₁ [mPa · s, 20° C.]: | 89 |
| CCP-V2-1 | 9.00% | K₁ [pN, 20° C.]: | 18.1 |
| PGP-2-2V | 10.00% | K₃ [pN, 20° C.]: | 19.3 |
| CCP-3OCF₃ | 3.00% | V₀ [V]: | 1.79 |
| PUQU-3-F | 2.00% | | |
| APUQU-2-F | 3.50% | | |
| APUQU-3-F | 7.00% | | |
| PGUQU-3-F | 4.00% | | |
| PGUQU-4-F | 5.00% | | |
| CPGP-5-2 | 1.50% | | |

### Example M51

| | | | |
|---|---|---|---|
| CC-3-V | 31.00% | Clearing point [° C.]: | 87.0 |
| CC-3-V1 | 9.00% | Δn [589 nm, 20° C.] | 0.1090 |
| CC-3-2V1 | 10.00% | Δε [kHz, 20° C.]: | +15.5 |
| PPQU-3-F | 3.00% | γ₁ [mPa · s, 20° C.]: | 94 |
| CCQU-3-F | 9.00% | K₁ [pN, 20° C.]: | 14.3 |
| PGUQU-3-F | 3.00% | K₃ [pN, 20° C.]: | 15.8 |
| PGUQU-4-F | 7.00% | V₀ [V]: | 1.02 |
| PGUQU-5-F | 7.00% | | |
| DPGU-4-F | 7.00% | | |
| DGUQU-3-F | 3.00% | | |
| DGUQU-4-F | 7.00% | | |
| CPPQU-3-F | 4.00% | | |

### Example M52

| | | | |
|---|---|---|---|
| CC-3-V | 32.50% | Clearing point [° C.]: | 87.0 |
| CC-3-V1 | 10.00% | Δn [589 nm, 20° C.] | 0.1083 |
| CC-3-2V1 | 10.00% | Δε [kHz, 20° C.]: | +15.5 |
| PPQU-3-F | 3.00% | γ₁ [mPa · s, 20° C.]: | 90 |
| CCP-V2-1 | 3.50% | K₁ [pN, 20° C.]: | 14.7 |
| APUQU-2-F | 8.00% | K₃ [pN, 20° C.]: | 15.9 |
| APUQU-3-F | 8.00% | V₀ [V]: | 1.03 |
| PGUQU-3-F | 3.00% | | |
| PGUQU-4-F | 4.00% | | |
| PGUQU-5-F | 4.00% | | |
| DPGU-4-F | 7.00% | | |
| DGUQU-4-F | 7.00% | | |

### Example M53

| | | | |
|---|---|---|---|
| CC-3-V | 31.50% | Clearing point [° C.]: | 88.0 |
| CC-3-V1 | 9.00% | Δn [589 nm, 20° C.] | 0.1086 |
| CC-3-2V1 | 9.00% | Δε [kHz, 20° C.]: | +15.2 |
| PPQU-3-F | 2.50% | γ₁ [mPa · s, 20° C.]: | 93 |
| CCQU-3-F | 9.00% | K₁ [pN, 20° C.]: | 14.6 |
| CCP-V2-1 | 1.50% | K₃ [pN, 20° C.]: | 15.5 |
| PGUQU-3-F | 3.50% | V₀ [V]: | 1.04 |
| PGUQU-4-F | 7.00% | | |
| PGUQU-5-F | 7.00% | | |
| DPGU-4-F | 7.00% | | |
| DGUQU-3-F | 3.00% | | |
| DGUQU-4-F | 7.00% | | |
| CPPQU-3-F | 3.00% | | |

### Example M54

| | | | |
|---|---|---|---|
| CC-3-V | 30.00% | Clearing point [° C.]: | 88.0 |
| CC-3-V1 | 10.00% | Δn [589 nm, 20° C.] | 0.1112 |
| PGP-2-2V | 2.50% | Δε [kHz, 20° C.]: | +19.2 |
| APUQU-2-F | 10.00% | γ₁ [mPa · s, 20° C.]: | 103 |
| APUQU-3-F | 9.00% | K₁ [pN, 20° C.]: | 14.6 |
| PGUQU-4-F | 7.00% | K₃ [pN, 20° C.]: | 15.2 |
| DGUQU-4-F | 8.00% | V₀ [V]: | 0.92 |
| CDUQU-3-F | 8.00% | | |
| DPGU-4-F | 6.00% | | |
| CC-3-2V1 | 7.50% | | |
| PPQU-3-F | 2.00% | | |

### Example M55

| | | | |
|---|---|---|---|
| CC-3-V | 29.50% | Clearing point [° C.]: | 93.0 |
| CC-3-V1 | 11.00% | Δn [589 nm, 20° C.] | 0.1089 |
| CCP-V2-1 | 7.50% | Δε [kHz, 20° C.]: | +18.9 |
| APUQU-2-F | 8.00% | γ₁ [mPa · s, 20° C.]: | 109 |
| APUQU-3-F | 9.00% | K₁ [pN, 20° C.]: | 14.7 |
| PGUQU-4-F | 7.00% | K₃ [pN, 20° C.]: | 16.0 |
| DGUQU-4-F | 9.00% | V₀ [V]: | 0.93 |
| CDUQU-3-F | 8.00% | | |
| DPGU-4-F | 5.50% | | |
| PPQU-3-F | 3.00% | | |
| CC-3-2V1 | 2.50% | | |

### Example M56

| | | | |
|---|---|---|---|
| CC-3-V | 23.00% | Clearing point [° C.]: | 88.0 |
| CC-3-V1 | 11.00% | Δn [589 nm, 20° C.] | 0.1117 |
| CC-3-2V1 | 11.00% | Δε [kHz, 20° C.]: | +18.3 |
| PPQU-3-F | 3.00% | γ₁ [mPa · s, 20° C.]: | 107 |
| PUQU-3-F | 3.00% | K₁ [pN, 20° C.]: | 14.8 |
| CCQU-3-F | 12.00% | K₃ [pN, 20° C.]: | 15.4 |
| PGUQU-3-F | 2.00% | V₀ [V]: | 0.95 |
| PGUQU-4-F | 7.00% | | |
| PGUQU-5-F | 7.00% | | |
| DPGU-4-F | 7.00% | | |
| DGUQU-3-F | 3.00% | | |
| DGUQU-4-F | 8.00% | | |
| CPPQU-3-F | 3.00% | | |

### Example 57

For the preparation of a PS-IPS mixture, 0.3% of compound RM-1

is added to mixture M56.

### Example M58

For the preparation of a PS-FFS mixture, 0.3% of compound RM-41

is added to mixture M56.

### Example M59

| | | | |
|---|---|---|---|
| CC-3-V | 30.50% | Clearing point [° C.]: | 100.5 |
| CC-3-V1 | 8.00% | Δn [589 nm, 20° C.] | 0.1220 |
| CC-3-2V1 | 9.50% | Δε [kHz, 20° C.]: | +4.8 |
| CCP-V-1 | 8.00% | γ₁ [mPa · s, 20° C.]: | 77 |
| CCP-V2-1 | 9.00% | K₁ [pN, 20° C.]: | 18.0 |
| DPGU-4-F | 5.00% | K₃ [pN, 20° C.]: | 17.3 |
| PGP-2-3 | 3.00% | V₀ [V]: | 2.05 |
| PGP-2-4 | 2.00% | | |
| PGP-2-2V | 10.00% | | |
| PGUQU-3-F | 2.00% | | |
| PGUQU-4-F | 8.00% | | |
| PPQU-3-F | 3.00% | | |
| CCPU-3-F | 2.00% | | |

### Example M60

| | | | |
|---|---|---|---|
| CC-3-V | 26.50% | Clearing point [° C.]: | 100.0 |
| CC-3-V1 | 10.00% | Δn [589 nm, 20° C.] | 0.1202 |
| CC-3-2V1 | 12.00% | Δε [kHz, 20° C.]: | +4.7 |
| CCP-V-1 | 12.00% | γ₁ [mPa · s, 20° C.]: | 80 |
| CCP-V2-1 | 6.00% | K₁ [pN, 20° C.]: | 17.6 |
| PGP-2-3 | 3.50% | K₃ [pN, 20° C.]: | 18.2 |
| PGP-2-2V | 10.00% | V₀ [V]: | 2.04 |
| PGUQU-3-F | 3.00% | | |
| PGUQU-4-F | 8.00% | | |
| PGUQU-5-F | 3.50% | | |
| CCPU-3-F | 3.00% | | |
| PPQU-3-F | 2.50% | | |

### Example M61

| | | | |
|---|---|---|---|
| CC-3-2V1 | 4.00% | Clearing point [° C.]: | 100.9 |
| CC-3-V | 31.00% | Δn [589 nm, 20° C.] | 0.1259 |
| CC-3-V1 | 3.00% | Δε [kHz, 20° C.]: | +5.8 |
| CCP-3OCF₃ | 6.00% | γ₁ [mPa · s, 20° C.]: | 86 |
| CCP-V-1 | 15.00% | K₁ [pN, 20° C.]: | 15.7 |
| CCP-V2-1 | 3.00% | K₃ [pN, 20° C.]: | 18.0 |
| CPGP-5-2 | 3.00% | V₀ [V]: | 1.74 |
| CPGU-3-OT | 5.50% | | |
| PGP-1-2V | 5.00% | | |
| PGP-2-2V | 5.00% | | |
| PGP-3-2V | 2.50% | | |
| PGUQU-3-F | 2.50% | | |
| PGUQU-4-F | 2.50% | | |
| PPGU-3-F | 1.00% | | |
| PUQU-3-F | 11.00% | | |

### Example M62

| | | | |
|---|---|---|---|
| CC-3-2V1 | 10.00% | Clearing point [° C.]: | 89.4 |
| CC-3-V | 25.50% | Δn [589 nm, 20° C.] | 0.1414 |
| CDUQU-3-F | 8.00% | Δε [kHz, 20° C.]: | +4.9 |
| CPGP-4-3 | 3.00% | γ₁ [mPa · s, 20° C.]: | 82 |
| CPGP-5-2 | 3.00% | K₁ [pN, 20° C.]: | 16.6 |
| CPGP-5-3 | 3.00% | K₃ [pN, 20° C.]: | 15.3 |
| DPGU-4-F | 5.50% | V₀ [V]: | 1.94 |
| PCH-301 | 10.00% | | |
| PGP-2-2V | 13.00% | | |
| PGUQU-4-F | 4.00% | | |
| PP-1-2V1 | 14.00% | | |
| PPGU-3-F | 1.00% | | |

LC mixture M62 is particularly suitable for 3D lens display applications.

1. A liquid-crystalline medium, comprising at least two liquid crystalline compounds, at least one of which is a compound of formula I,
in which
R¹ denotes an alkyl or alkoxy radical having 1 to 15 C atoms, where, in addition, one or more CH₂ groups in these radicals are optionally replaced, independently of one another, by —C≡C—, —CF₂O—, —CH═CH—,
—O—, —CO—O— or —O—CO— in such a way that O atoms are not linked directly to one another, and in which, in addition, one or more H atoms are optionally replaced by halogen.

2. The liquid-crystalline medium according to claim 1, wherein R¹ in formula I denotes a straight-chain alkyl radical, in which, in addition, one or more CH₂ groups are optionally replaced by —CH═CH—.

3. The liquid-crystalline medium according to claim 1, comprising at least one compound of formulae I-1 to I-5

4. The liquid-crystalline medium according claim 1, additionally comprising at least one compound of formulae II and/or III,
in which
A denotes 1,4-phenylene or trans-1,4-cyclohexylene,
a denotes 0 or 1,
R³ denotes alkenyl having 2 to 9 C atoms,
and
R⁴ has the meanings indicated for R¹ in claim 1.

5. The liquid-crystalline medium according to claim 1, additionally comprising at least one compound of formulae,
in which R^{3a} and R^{4a} each, independently of one another, denote H, CH₃, C₂H₅ or C₃H₇, and “alkyl” denotes a straight-chain alkyl group having 1 to 8 C atoms.

6. The liquid-crystalline medium according to claim 1, additionally comprising at least one compound of formulae IV to VIII,
in which
R⁰ denotes an alkyl or alkoxy radical having 1 to 15 C atoms, where, in addition, one or more CH₂ groups in these radicals are optionally replaced, independently of one another, by —C≡C—, —CF₂O—, —CH═CH—,
—O—, —CO—O— or —O—CO— in such a way that O atoms are not linked directly to one another, and in which, in addition, one or more H atoms are optionally replaced by halogen,
X⁰ denotes F, Cl, a mono- or polyfluorinated alkyl or alkoxy radical having 1 to 6 C atoms, a mono- or polyfluorinated alkenyl or alkenyloxy radical having 2 to 6 C atoms,
Y¹⁻⁶ each, independently of one another, denote H or F,
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO—, —CF₂O— or —OCF₂—, in the formulae V and VI also a single bond, and
r denotes 0 or 1.

7. The liquid-crystalline medium according to claim 6, additionally comprising at least one compound of formulae Va to Vj,

8. The liquid-crystalline medium according to claim 6, additionally comprising at least one compound of formulae VI-1a to VI-1d,

9. The liquid-crystalline medium according to claim 6, additionally comprising at least one compound of formulae VI-2a to VI-2f,

10. The liquid-crystalline medium according to claim 6, additionally comprising at least one compound of formulae X and/or XI,
in which
Y¹⁻⁴ each, independently of one another, denote H or F, and
each, independently of one another, denote

11. The liquid-crystalline medium according to claim 1, additionally comprising at least one compound of formula XII,
in which
R¹ and R² each, independently of one another, denote alkyl, alkenyl, alkoxy, oxaalkyl, fluoroalkyl or alkenyloxy, each having up to 9 C atoms, and Y¹ denotes H or F.

12. The liquid-crystalline medium according to claim 6, additionally comprising at least one compound of formulae XIII to XVI,

13. The liquid-crystalline medium according to claim 1, comprising 1-30% by weight of compounds of the formula I.

14. The liquid-crystalline medium according to claim 1, additionally comprising at least one UV stabiliser and/or antioxidant.

15. The liquid-crystalline medium according to claim 1, additionally comprising at least one polymerizable compound.

16. The liquid-crystalline medium according to claim 15, wherein the polymerizable compound is one of RM-1 to RM-83:

17. A process for the preparation of a liquid-crystalline medium according to claim 1, comprising mixing at least one compound of formula I with at least one further mesogenic compound and optionally with at least one additive(s) and/or at least one polymerizable compound.

18. An electro-optical liquid-crystal display containing a liquid-crystalline medium according to claim 1.

19. A TN, STN, TN-TFT, OCB, IPS, PS-IPS, FFS, PS-FFS display, shutter spectacle, LC lens or positive VA displays comprising the liquid crystalline medium according to claim 1.

20. A compound of formula I
in which
R¹ denotes an alkyl or alkoxy radical having 1 to 15 C atoms, where, in addition, one or more CH₂ groups in these radicals are optionally replaced, independently of one another, by —C≡C—, —CF₂O—, —CH═CH—,
—O—, —CO—O— or —O—CO— in such a way that O atoms are not linked directly to one another, and in which, in addition, one or more H atoms are optionally replaced by halogen.

21. The compound according to claim 20 of the formulae I-1 to I-5
